(19) United States
(12) Patent Application Publication
(10) Pub. No.: US 2025/0200359 A1
(43) Pub. Date: Jun. 19, 2025

(54) MACHINE LEARNING MODELS FOR TUNING AN ION IMPLANTER

(71) Applicant: Applied Materials, Inc., Santa Clara, CA (US)

(72) Inventor: Richard Allen SPRENKLE, South Hamilton, MA (US)

(73) Assignee: Applied Materials, Inc., Santa Clara, CA (US)

(21) Appl. No.: 18/545,691

(22) Filed: Dec. 19, 2023

(51) Int. Cl. G06N 3/08

(52) U.S. Cl. CPC G06N 3/08

(57) ABSTRACT

Machine learning models to support tuning of an ion implanter are described. For example, a method may comprise receiving a set of control parameters and associated values for an ion implanter by a control model, the control model comprising an artificial neural network (ANN); predicting a set of process parameters and associated values for the ion implanter based on the set of control parameters and associated values by the control model; modifying at least one process parameter and associated value from the set of process parameters and associated values for the ion implanter; and analyzing modifications to the set of control parameters and associated values based on the modification of the at least one process parameter by a saliency model. Other embodiments are described and claimed.

### BACKGROUND

An ion implanter is a device used in the semiconductor industry for doping or modifying the properties of materials. It is specifically designed to precisely introduce impurities, known as dopants, into target material to create semiconductor devices like transistors. The target material is usually a silicon wafer. The process involves accelerating ions to high speeds using an electric field and directing them towards the target material. The accelerated ions penetrate a substrate of the target material, displacing atoms and creating a controlled distribution of dopants in the substrate. The ion implanter typically comprises various components, such as an ion source to generate the desired ions, an accelerator to increase their energy, a mass analyzer to select the desired ions, and a beamline system to direct and focus the ion beam onto the substrate. The implanter settings, such as energy and current, are carefully controlled to achieve the desired dopant depth and concentration profiles. By precisely controlling the ion energy and dose, an ion implanter allows the customization of material properties. It plays a crucial role in the fabrication of integrated circuits, where different dopants create various regions necessary for device functionality, such as transistor gates, source, and drain regions. Overall, an ion implanter is a vital tool in the semiconductor industry for precisely introducing controlled impurities into materials, enabling the creation of advanced electronic devices.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an ion implanter in accordance with one embodiment.

FIG. 2 illustrates an ion implanter in accordance with one embodiment.

FIG. 3 illustrates an inferencing system in accordance with one embodiment.

FIG. 4 illustrates a graphical user interface (GUI) in accordance with one embodiment.

FIG. 5 illustrates an artificial neural network in accordance with one embodiment.

FIG. 6 illustrates an artificial neural network in accordance with one embodiment.

FIG. 7 illustrates an artificial neural network in accordance with one embodiment.

FIG. 8 illustrates an artificial neural network in accordance with one embodiment.

FIG. 9 illustrates a logic flow in accordance with one embodiment.

FIG. 10 illustrates a training device in accordance with one embodiment.

FIG. 11 illustrates a training system in accordance with one embodiment.

FIG. 12 illustrates computer readable medium (CRM) in accordance with one embodiment.

FIG. 13 illustrates a computing system in accordance with one embodiment.

FIG. 14 illustrates a communications system in accordance with one embodiment.

### DETAILED DESCRIPTION

Embodiments are generally directed to artificial intelligence (AI) and machine learning (ML) techniques for controlling a configuration or operation of an ion implanter. Some embodiments are particularly directed to AI and ML techniques for automatically tuning one or more components of an ion implanter for directing, controlling and shaping an ion beam as it travels from an ion source to a target material, such as a silicon wafer. Specifically, embodiments implement a control model using a saliency network for determining priority of control input tuning and calibration. Saliency techniques analyze a control model implemented as a deep neural network (DNN) to assess stability, ease of tuning, and prioritizing and/or restricting which controls are used and in which direction they are applied to optimize ion beam characteristics or properties in an ion implanter. Examples of saliency techniques include without limitation layer-wise relevance propagation, gradient-based methods, Shapley additive explanations (SHAP), and other saliency techniques. Other embodiments are described and claimed.

In one embodiment, for example, a software application may comprise instructions suitable for execution by logic circuitry or processing circuitry. The software application is generally arranged to assist in tuning operations for an ion implanter. The software application includes a graphical user interface (GUI) to present multiple GUI elements representing a set of control parameters for an ion implanter, with each control parameter having an associated information field to present one or more values for the control parameter. A control parameter generally corresponds to a hardware or software control input setting that controls a particular configuration or operation of a component of the ion implanter. The GUI also presents multiple GUI elements representing a set of process parameters for the ion implanter, with each process parameter having an associated information field to receive configurable values for the process parameter. A process parameter generally corresponds to a beam property, or a metric or metrology associated with a beam property, for an ion beam generated by the ion implanter.

An operator may use the GUI to select or enter defined threshold values in the information fields associated with control parameters of interest to the operator, referred to herein as a target set of control parameters. The software application implements a ML model, sometime referred to as a feed forward model or a control model, trained to accept as input the target set of control parameters and associated values, and the control model makes a prediction or inference for a set of process parameters and associated values that provides information about beam properties of an ion beam that is produced using the target set of control parameters. This allows an operator to adjust the target set of control parameters in an attempt to arrive at a desired set of beam properties for a given application.

A control model that maps control parameters to process parameters can predict outputs extremely fast. However, during naive setups of an ion beam or when using nascent ML models, the ion implanter does not have a context for which control input to adjust first or in which direction to start. As a result, an operator may need to manually adjust the control parameters to arrive at a set of process parameters for a given application. This can be a tedious and time consuming process. In some cases, the operator may find it easier to define a set of process parameters and have the control model determine a set of control parameters that produces an ion beam with beam properties corresponding to the process parameters. Generally, this requires an inverted control model, which is a reverse of the control model. However, an inverted control model may suffer from a duplication challenge, where a single control parameter maps to multiple process parameters. Without a one-to-one correspondence between input parameters and output parameters, the control model cannot be reversed to form the inverted control model.

In lieu of an inverted model, embodiments implement a feed forward control model with a saliency network to support the control model in order to determine a priority of control input tuning and calibration. Embodiments analyze a neural network model to identify stability (e.g., mapping variation on input to impact on metrics) and tunability (e.g., mapping variation of a specific metric to a set of inputs) and uses these criteria to choose which tuning windows to prioritize. Unlike a Gaussian process (GP) model that is limited to analyzing impulse response, embodiments leverage a forward approach that can be analyzed in both directions. In a forward direction, embodiments analyze how a single input impacts multiple outputs. In a backward direction, embodiments analyze how a single metric is impacted by multiple inputs and which control parameters are affected by metrics. Further, embodiments use a ML model that is multi-recipe capable and therefore reduces or eliminates a need for developing an ML model per recipe.

In various embodiments, the saliency analysis analyzes a difference in a measured output to a target output, and it determines what changes to the input vector (e.g., control parameters) are most likely to correct the measured output vector (e.g., process parameters) back to the target output. Specifically, embodiments implement a saliency approach to assess a desired correction value in current metrics and suggests a correction in the inputs in both direction and magnitude for each input to do a simultaneous correction to metrology. For example, small variations are made to one or more of the outputs at a known location. Small perturbations are used for both: (1) finding a correction to the inputs to correct an output to the desired value; and (2) for assessing which inputs are associated with a change to a single output variable and in what proportion.

Embodiments perform a saliency network analysis to attribute variations on output to variations on the input. This is done in a similar fashion to backpropagation learning, but rather than using the data to adjust all weights and biases in the network, embodiments assume they are fixed and instead measures the net change on the input. For example, to analyze sensitivity in the control model (e.g., a feed forward model), embodiments perturb one control input and analyzes changes on the metrics. Additionally or alternatively, embodiments may correct a single metric or bring several metrics back to target values. This gradient “repair” to the output vector is worked back through the feed forward model to analyze a most likely gradient change on the input vector. This approach greatly speeds up the search for determining what changes are needed for the input vector to make the target changes to the output vector. This approach can be used to assess tunability (e.g., orthogonality of inputs to outputs), stability (e.g., strong weights on inputs that can vary), or suggest changes to inputs to correct outputs. Because of its ability to score tunability and stability, it can be used to facilitate the inversion of the model by removing duplicate output vectors. In this manner, using a control model in combination with a saliency network may effectively allow the control model to operate as an inverted control model.

For example, an operator may use the GUI to select or enter defined threshold values in the information fields associated with process parameters of interest to the operator, referred to herein as a target set of process parameters. The software application implements a ML model trained to accept as input the target set of process parameters and associated values, and the ML model makes a suggestion, prediction or inference for a set of control parameters and associated values that when applied to various components of the ion implanter produces an ion beam with beam properties that match the target set of process parameters. The predicted changes to the input vector can be automatically scored and selected based on different criteria, such as stability, tunability, and other criteria. Additionally, or alternatively, the ML model may recommend a single step, multivariate change. Embodiments include techniques to speed up sensitivity analysis to better score stability and ease of tune. This provides a significant technical advantage over conventional techniques, since the operator does not need to manually and repetitively adjust control parameters in an attempt to arrive at a desired set of beam properties for a given application.

By way of background, ion implanters use a series of optical elements to extract ions, accelerate to precise energies, and form a stable uniform beam for implanting ions at specific depths in various substrates. These expensive machines must work over a wide range of ion mass and charge states, and manipulate the various optical elements to achieve a desired structure on a target material, such as a silicon wafer. As structures have become smaller and taller, operators need repeatable beam shapes with high uniformity, and that can achieve specific angle uniformity and distributions for exacting process requirements.

An operator for an ion implanter typically tunes various components of the ion implanter, sometimes referred to as “beamline” elements, by modifying one or more control parameters for the components to determine an effect on process parameters for the components. The components of an ion implanter shape a trajectory of an ion beam, focuses the ion beam, and ensures its stability and accuracy throughout the implantation process. Examples of components for the ion implanter may include electrostatic lenses, magnetic lenses, aperture systems, beam scanning systems, mass analyzers, Faraday cups, beam diagnostic tools, and other components.

Tuning an ion implanter is necessary for generating an ion beam with a set of target beam properties suitable for an intended application. Examples of tuning operations may include calibrating the ion implanter to ensure accurate measurements, adjusting a beam current to the desired level by changing the extraction voltage or aperture size, setting an appropriate ion energy to achieve the desired penetration depth in the target material by adjusting an accelerator voltage or a bias potential to control the ion energy to affect a depth of ion penetration and consequently the resulting doping profile, fine-tuning beam optics to ensure proper focusing and alignment by adjusting magnetic fields and beamline components to shape and direct the ion beam accurately onto the target area, attaining uniformity across the target area by adjusting the beam distribution for a beam scanning pattern or beam shaping devices, controlling a dose implanted by adjusting the beam current and the time of exposure to the ion beam, and other tuning operations. After tuning the ion implanter, a controller may conduct regular characterization tests to verify the achieved beam properties. This can involve metrology techniques such as secondary ion mass spectrometry (SIMS) or sheet resistance measurements.

An operator for an ion implanter typically tunes components of the ion implanter by modifying one or more control parameters for the components to determine an effect on one or more process parameters for the components. Each control parameter corresponds to a hardware or software setting for a component of the ion implanter. Examples of control parameters include a charge parameter, an energy parameter, an acceleration or deceleration parameter, a dopant and flow parameter, a diluent and flow parameter, a source parameter, an analyzer parameter, a corrector parameter, a suppression parameter, a focus parameter, a scan parameter, a quadrupole lens current parameter, a post-acceleration voltage parameter, and other control parameters. Each process parameter corresponds to a beam property for an ion beam generated by the ion implanter. Examples of process parameters include a beam height parameter, a beam width parameter, full half height maximum (FHHM) parameter, a vertical within device angle (VWIDA) parameter, a VWIDA mean (VWIDAM) parameter, a horizontal within device angle (HWIDA) parameter, a HWIDA mean (HWIDAM) parameter, a standard deviation of VWIDA (VWIDAS) parameter, a standard deviation of HWIDA mean (HWIDAS) parameter, a vertical intensity (VI) parameter, a width parameter, a spotscore parameter, an energy parameter, a region of interest (ROI) current parameter, a uniformity parameter, and other process parameters.

Changing a control parameter for a component of the ion implanter affects a beam property of an ion beam as it implants ions into a substrate of a silicon wafer. This is typically a manually-intensive process, where the operator manually changes values for control parameters and evaluates changes in values for process properties important for a given application. This process continues in an iterative fashion until a particular configuration for the control parameters produces the desired output values for the process parameters.

An operator typically selects a set of control parameters and enters defined threshold values for each of the control parameters via a GUI for a software tool. The software tool generates a set of process parameters and values for the process parameters corresponding to the control parameters. By way of example, assume an operator desires to have the ion implanter generate an ion beam consistent with process parameters having values above a set of defined threshold values (or within a window around the defined threshold values), such as a process parameter (PP) 1 (PP1) of 17.5 mm, a PP2 of 0.7, and a PP3 of 0.07 (or better). Further assume the operator uses the GUI for a software application to select an input control vector subset with values for four control parameters, such as a control parameter (CP) 1 (CP1) of 52.56 kilovolts (kV), a CP2 of 6.750 kV, a CP3 of −39.80, and a CP4 of 3.491 kV. The software application may generate and display an output metrology vector subset of beam properties corresponding to the input control vector subset, such as a PP1 of 16.67, a PP2 of 0.6996, a PP3 of 0.07766, a PP4 of 0.000, a PP5 of 80.98, a PP6 of 150.6 mm, and a PP7 of 0.000. While the PP3 of 0.7760 meet the defined threshold value, the PP1 of 16.67 and PP2 of 0.6996 are below the defined threshold values. As such, the operator must manually and repeatedly adjust one or more values of the four control parameters until the beam property threshold values are all exceeded for the process parameters. This is a typically a tedious and time-consuming task for the operator, particularly when there is a large number of control parameters and process parameters.

Embodiments attempt to solve these and other problems. Rather than continuously modifying a set of control parameters in an attempt to determine a target set of process parameters, a software application implements a ML model trained to accept as input a target set of process parameters, and it makes a prediction or inference for a target set of control parameters that produce the target set of process parameters. Continuing with the previous example, assume an operator targets a set of process parameters, such as the PP1 of 17.5 mm, the PP2 of 0.7, and the PP3 of 0.07 (or better). In this case, the operator uses the GUI for the software tool to select an output metrology vector subset of beam properties. The ML model receives the output metrology vector subset as an input to the ML model. For example, assume the output metrology vector subset includes a PP1 of 18.53 mm, a PP2 of 0.7170, a PP3 of 0.07344, a PP4 of 0.000, a PP5 of 72.86, a PP6 of 190.0 mm, and a PP7 of 0.000 mm. The ML model of the controller receives as input the output metrology vector subset, and it predicts or infers an input control vector subset comprising a CP1 of 17.00 kV, a CP2 of 6.000 kV, a CP3 of 7.400, and a CP4 of 0.3750. The software application can then automatically configure one or more components of the ion implanter with the input control vector subset comprising a CP1 of 17.00 kV, CP2 of 6.000 kV, a CP3 of 7.400, and a CP4 of 0.3750 to cause the ion implanter to generate an ion beam with beam properties that match the output metrology vector subset of a PP1 of 18.53 mm, a PP2 of 0.7170, a PP3 of 0.07344, a PP4 of 0.000, a PP5 of 72.86, a PP6 of 190.0 mm, and a PP7 of 0.000 mm. By defining a target set of process parameters as input to the ML model, rather than the reverse, the ML model quickly and efficiently predicts a target set of control parameters that produces the target set of process parameters. As such, embodiments reduce an amount of time necessary to tune components of an ion implanter to meet specific requirements of an operator.

The use of AI and ML techniques for automatically tuning an ion implanter provides a significant technical solution that overcomes several technical challenges, including process repeatability, cross-tool process matching, decreased tune time, periodic maintenance endpoint detection, access to the full tool entitlement of beam shapes, and simplifying the customers' ability to quickly identify desired beam shape characteristics and establish appropriate tune window for reliable and repeatable tuning. Accordingly, tuning an ion implanter consumes less electronic resources, including: device resources such as compute and memory resources; device platform resources such as input/output (I/O) devices, peripheral components, and interfaces; network resources such as interconnect, wired and wireless bandwidth and associated protocol stack interfaces; cloud computing and data center resources; and other valuable and scarce computing and communications resources.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

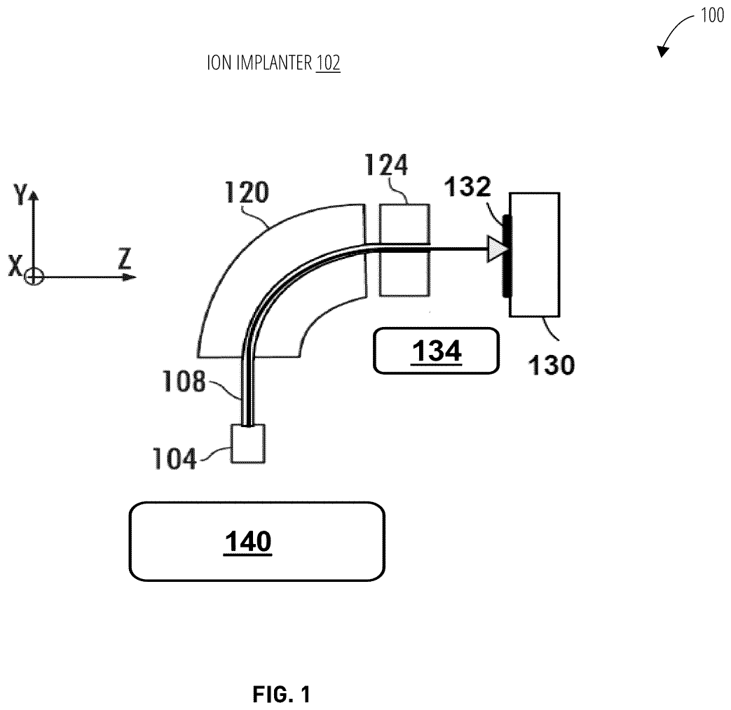

FIG. 1 depicts a schematic view of a system 100 including an ion implanter 102, in accordance with embodiments of the disclosure. The ion implanter 102 may include an ion source 104 for producing an ion beam 108, and a series of beam-line components. The ion source 104 may comprise a chamber for receiving a flow of gas and generating ions. The ion source 104 may also comprise a power source and an extraction electrode assembly (not shown) disposed near the chamber.

Suitable ions for ion beam 204 may include any ion species at a suitable ion energy, including ions such as phosphorous, boron, argon, indium, BF₂, nitrogen, oxygen, hydrogen, inert gas ions, and metallic ions, according to some non-limiting embodiments, with ion energy being tailored according to the exact ion species used.

The beam-line components may include, for example, a mass analyzer 120, and an end station 130, to house and manipulate a substrate 132 that is to intercept the ion beam 108. Thus, the ion source 104, as well as additional beamline components, will provide the ion beam 108 to the substrate 132, having a suitable ion species, ion energy, beam size, and beam angle, among other features, for implanting ions into the substrate 132.

In FIG. 1, in addition to a mass analyzer, according to various non-limiting embodiments, additional components that lie downstream to the ion source 104 may be included. These additional components may include components to accelerate ion beam 108, decelerate ion beam 108, focus ion beam 108, steer ion beam 108, collimate ion beam 108, mass filter ion beam 108, and scan ion beam 108, among other operations. Examples of components to accelerate an ion beam 108 include a DC accelerator column, an RF linear accelerator, and a tandem accelerator, as known in the art. Examples of components to scan the ion beam 108 include an electrostatic scanner or a magnetic scanner. An example of a component to focus the ion beam 108 includes a quadrupole lens.

The ion implanter 102 may further include one or more measurement components, arranged at one or more locations along the beamline, between ion source 104 and end station 130. For simplicity, these components are shown as beam measurement component 134. Examples of beam measurement component 134 include ion beam current measurement devices, ion beam angle measurement devices, ion beam energy measurement devices, and ion beam size measurement devices. In one example, the beam measurement component 134 may be a current detector such as a scanning detector, a closed loop current detector, and in particular a closed loop Faraday current detector (CLF), for monitoring beam current provided to the substrate 116. The beam measurement component may be disposed to intercept the ion beam 108 and may be configured to record beam current of the ion beam 108, either at a fixed position, or as a function of position. In some examples, the beam current of ion beam 108 may be measured for a region of interest (ROI), such as the region of the substrate 116.

The ion implanter 102 may also include a control system 140, which system may be included as part of ion implanter 102, to control operations such as adjustments to ion beam parameters. These parameters may include ion beam energy, ion beam size, ion beam current, ion beam angle, and so forth. In turn, the control system 140 may adjust and control these parameters by adjusting the operation of various components of the aforementioned beamline components of the ion implanter 102. The control system 140 may be included in the ion implanter 102 or may be coupled to the ion implanter 102 in order to implement the AI and ML techniques for automatically tuning one or more components of the ion implanter 102 as set forth in the embodiments to follow.

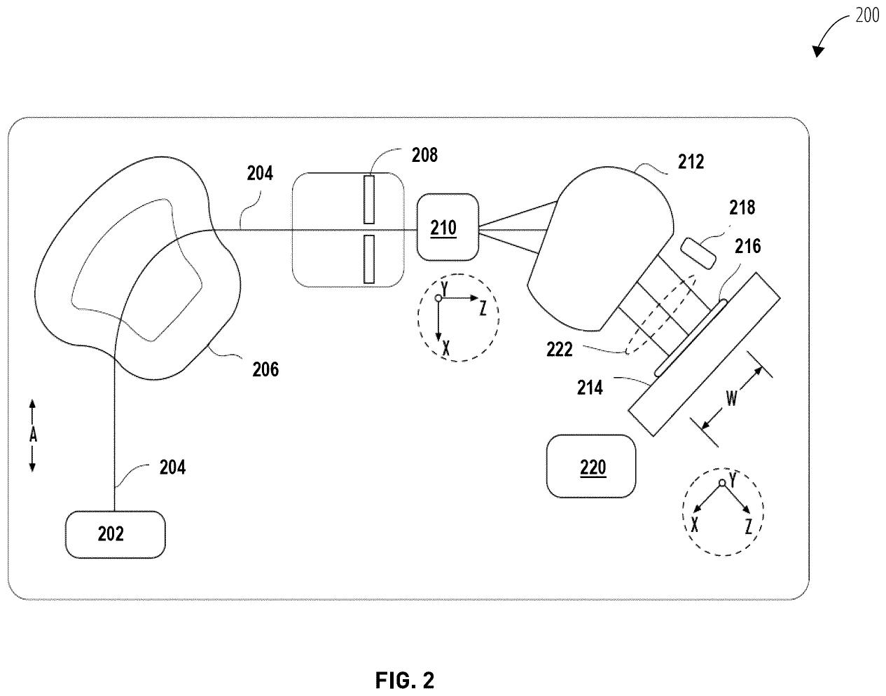

FIG. 2 depicts in block form of a beamline ion implanter, shown as the ion implanter 200, in accordance with various additional embodiments of the disclosure. The ion implanter 200 includes an ion source 202 configured to generate an ion beam 204. Suitable ions for ion beam 204 may include any ion species at a suitable ion energy, including ions such as phosphorous, boron, argon, indium, BF₂, nitrogen, oxygen, hydrogen, inert gas ions, and metallic ions, according to some non-limiting embodiments, with ion energy being tailored according to the exact ion species used.

The ion beam 204 may be provided as a spot beam scanned along a direction, such as the X-direction. In the convention used herein, the Z-direction refers to a direction of an axis parallel to the central ray trajectory of an ion beam 204. Thus, the absolute direction of the Z-direction, as well as the X-direction, where the X-direction is perpendicular to the Z-direction, may vary at different points within the ion implanter 200 as shown. The ion beam 204 may travel through a mass analysis component, shown as analyzer magnet 206, thence through a mass resolving slit 208, and through a collimator 212 before impacting a substrate 216 disposed on a substrate stage 214, which stage may reside within an end station (not separately shown). The substrate stage 214 may be configured to scan the substrate 216 at least along the Y-direction in some embodiments. In some embodiments, the substrate stage 214 may be configured to tilt about the X-axis or Y-axis, so as to change the beam angle of ion beam 204 when impacting substrate 216.

In the example shown in FIG. 2, the ion implanter 200 includes a beam scanner 210. When the ion beam 204 is provided as a spot beam, the beam scanner 210 may scan the ion beam 204 along the X-direction, producing a scanned ion beam, that enters the collimator 212 and exits in a fashion such that the ion beam 204 impacts the substrate 216 as a scanned ion beam 222 that scanned at the substrate along the X-direction (note the local X-direction in absolute sense may differ at different locations along the beamline as shown). Generally, the ion beam 204 may be scanned back and forth across a substrate 216 for any suitable number of scans, with an accompanying scanning of the substrate 216 in an orthogonal direction to the beam scan direction, until the targeted dose is implanted into substrate 216. The width of the resulting scanned spot beam may be comparable to the width W of the substrate 216 In various embodiments, the ion beam 204 may be scanned at a frequency of several Hz, 10 Hz, 100 Hz, up to several thousand Hz, or greater.

In various non-limiting embodiments, the ion implanter 200 may be configured to deliver ion beams for “low” energy or “medium” energy ion implantation, such as a voltage range of 1 kV to 300 kV, corresponding to an implant energy range of 1 keV to 300 keV for singly charged ions. As discussed below, the scanning of an ion beam provided to the substrate 116 may be adjusted depending upon calibration measurements before substrate ion implantation using a scanned ion beam. In other embodiments, the ion implanter 200 may be provided with an acceleration component, such as a DC acceleration column, an RF linear accelerator, or a tandem accelerator, where the ion implanter is capable to accelerate the ion beam 204 to energy of 1 MeV, 3 MeV, 5 MeV, or higher energy.

The ion implanter 200 may further include one or more measurement components, arranged at one or more locations along the beamline, between ion source 202 and substrate stage 214. For simplicity, these components are shown as beam measurement component 218. Examples of beam measurement component 218 include ion beam current measurement devices, ion beam angle measurement devices, ion beam energy measurement devices, and ion beam size measurement devices. In one example, the beam measurement component 218 may be a current detector such as a scanning detector, a closed loop current detector, and in particular a closed loop Faraday current detector (CLF), for monitoring beam current provided to the substrate 216. The beam measurement component may be disposed to intercept the ion beam 204 and may be configured to record beam current of the ion beam 204, either at a fixed position, or as a function of position. In some examples, the beam current of ion beam 204 may be measured for a region of interest (ROI), such as the region of the substrate 216.

The ion implanter 200 may also include a control system 220, which may be included as part of ion implanter 200, to control operations such as adjustments to ion beam parameters. These parameters may include ion beam energy, ion beam size, ion beam current, ion beam angle, and so forth. In turn, the control system 220 may adjust and control these parameters by adjusting the operation of various components of the aforementioned beamline components of the ion implanter 200. The control system 220 may be included in the ion implanter 200 or may be coupled to the ion implanter 200 in order to implement the AI and ML techniques for automatically tuning one or more components of the ion implanter 200 as set forth in the embodiments to follow.

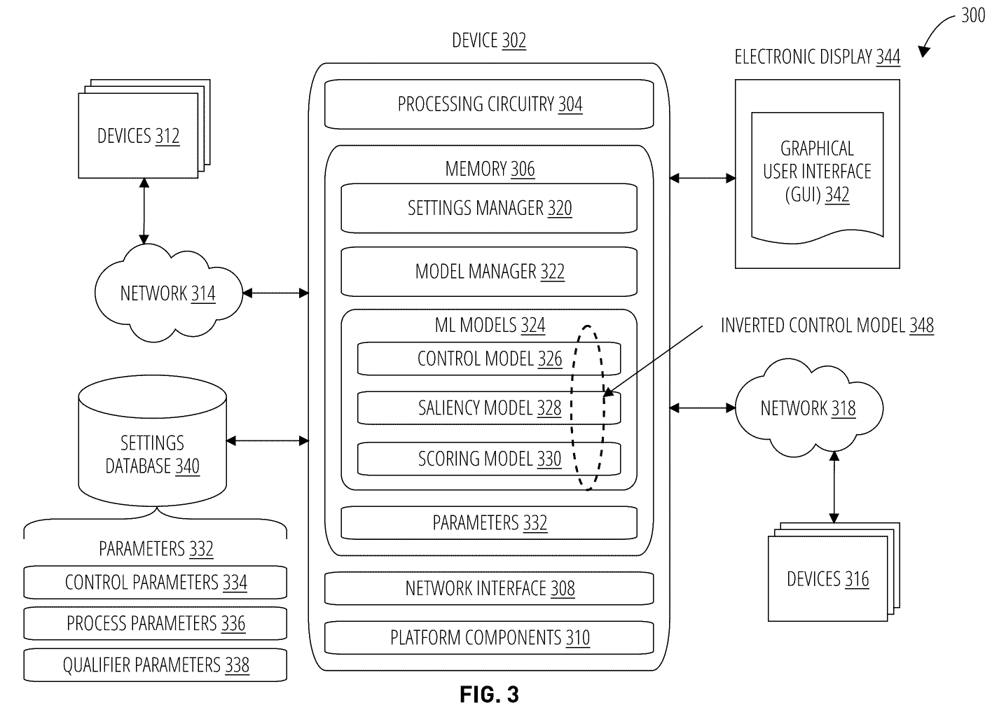

FIG. 3 illustrates an embodiment of an inferencing system 300. The inferencing system 300 may be suitable for implementing one or more embodiments as described herein. In one embodiment, for example, the inferencing system 300 may implement one or more ML models 324. For example, the ML models 324 may include a control model 326 trained to receive as input a set of control parameters 334 and predict a set of process parameters 336 corresponding to the control parameters 334. Further, the inferencing system 300 may implement a saliency model 328, which is a duplicate of the control model 326. The saliency model 328 may perturb an input vector 608 or an output vector 610 of the saliency model 328 to find corresponding deviations in the input vector 608 or the output vector 610. The inferencing system 300 may also implement a scoring model 330 to score the deviations. A model manager 322 may automatically surface a recommendation based on the scored deviations.

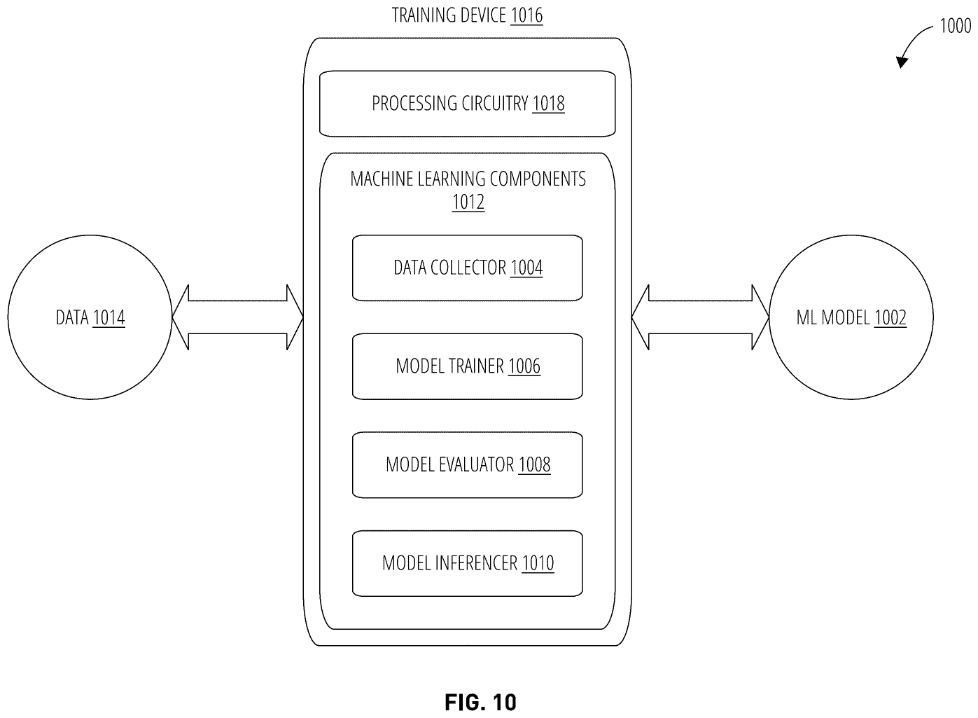

For example, the saliency model 328 may implement one or more saliency techniques for the duplicate of the control model 326 with locked hidden layers 604 to perform a sensitivity analysis to determine how changes to one or more of the control parameters 334 impact the predicted process parameters 336. In another example, the saliency model 328 may also implement one or more saliency techniques for the duplicate of the control model 326 to determine how changes to one or more of the process parameters 336 impact the input control parameters 334. The saliency model 328 can assess a target correction value in current metrics and suggest a correction in the inputs in both direction and magnitude for each input to do a simultaneous correction to metrology. The scoring model 330 may score the results of the changes using various scoring techniques. In this manner, the combination of the control model 326, the saliency model 328, and the scoring model 330 allows the ML models 324 to effectively operate as an inverted control model. A training system suitable for training the ML models 324 is described with reference to FIG. 10.

As depicted in FIG. 3, the inferencing system 300 may comprise a device 302 communicatively coupled to a set of devices 312 via a network 314. The device 302 may also be communicatively coupled to a set of devices 316 via a network 318. It may be appreciated that the inferencing system 300 may have more or less devices than shown in FIG. 3 with a different network topology as needed for a given implementation. Embodiments are not limited in this context.

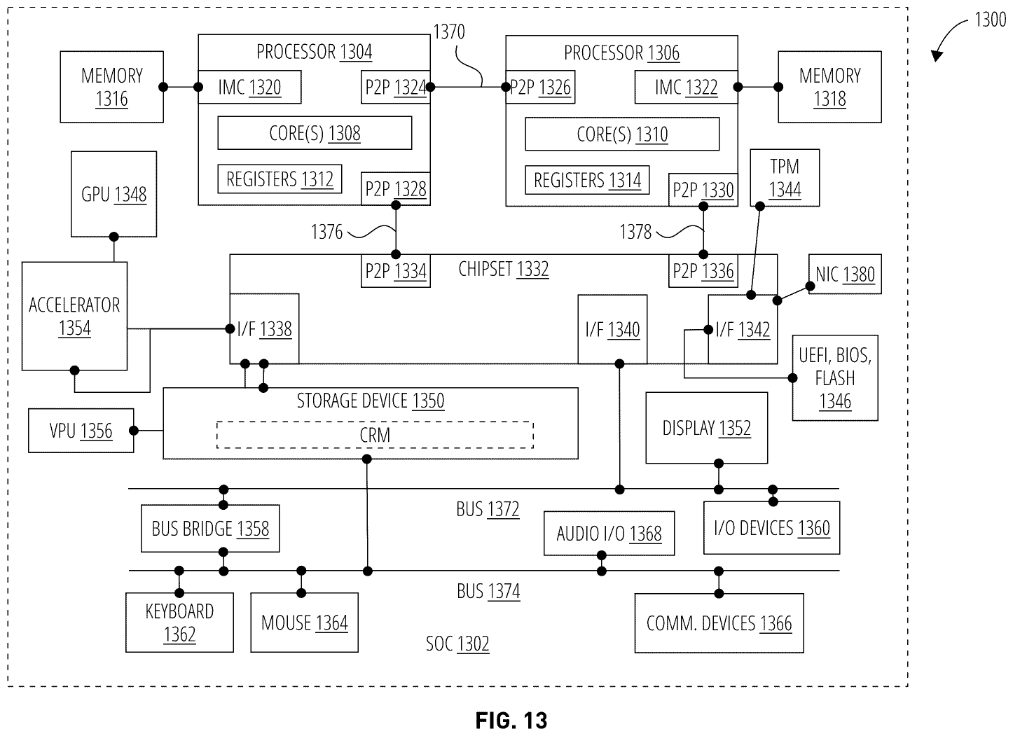

In various embodiments, the device 302 may comprise various hardware elements, such as a processing circuitry 304, a memory 306, a network interface 308, and a set of platform components 310. Similarly, the devices 312 and/or the devices 316 may include similar hardware elements as those depicted for the device 302. The device 302, devices 312, and devices 316, and associated hardware elements, are described in more detail with reference to a computing architecture 1300 as depicted in FIG. 13.

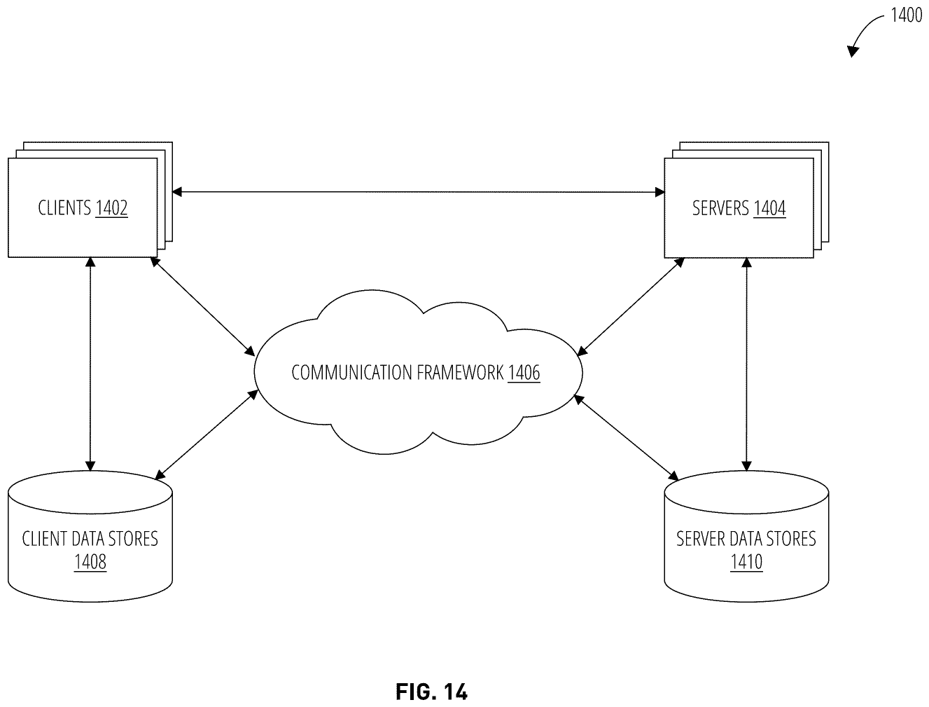

In various embodiments, the devices 302, 312 and/or 316 may communicate control, data and/or content information associated with the ion implanter 102 via one or both network 314, network 318. The network 314 and the network 318, and associated hardware elements, are described in more detail with reference to a communications architecture 1400 as depicted in FIG. 14.

The memory 306 may comprise a set of computer executable instructions that when executed by the processing circuitry 304, causes the processing circuitry 304 to manage a configuration or operation of the ion implanter 102. As depicted in FIG. 3, for example, the memory 306 may comprise a settings manager 320, a model manager 322, a set of ML models 324, and a set of parameters 332, among other parts. The ML models 324 include a control model 326, a saliency model 328, and a scoring model 330. The parameters 332 include one or more control parameters 334, process parameters 336, and qualifier parameters 338. Additionally or alternatively, the parameters 332 are stored in a settings database 340 accessible by the device 302. Although FIG. 3 depicts the inferencing system 300 depicted as software elements executing on hardware elements, it may be appreciated that the software elements may be implemented as hardware elements or a combination of software elements and hardware elements as needed for a given set of design constraints. Embodiments are not limited in this context.

The settings manager 320 generally manages parameters 332 associated with one or more components of the ion implanter 102. The settings manager 320 may perform one or more change, read, update or delete (CRUD) operations to manage the parameters 332 stored in the settings database 340 or the memory 306. The settings manager 320 may also read parameters 332 from a data source, such as components of the ion implanter 102 or input data from the GUI 342 of the electronic display 344. The settings manager 320 may also write parameters 332 to a data sink, such as components of the ion implanter 102 or as output data for presentation on the GUI 342 of the electronic display 344. Read operations may be useful for retrieving a current set of parameters 332 from components of the ion implanter 102 or the GUI 342 for updating by one or more of the ML models 324. Write operations may be useful for sending an updated set of parameters 332 from the ML models 324 to components of the ion implanter 102 or the GUI 342. The read and write operations may facilitate automated calibration and tuning of the components of the ion implanter 102, such as during normal preventative maintenance (PM) cycles, responsive to lower production yields, or emergency disruptions. The read and write operations may also facilitate design and testing of the components of the ion implanter 102, such as for new applications.

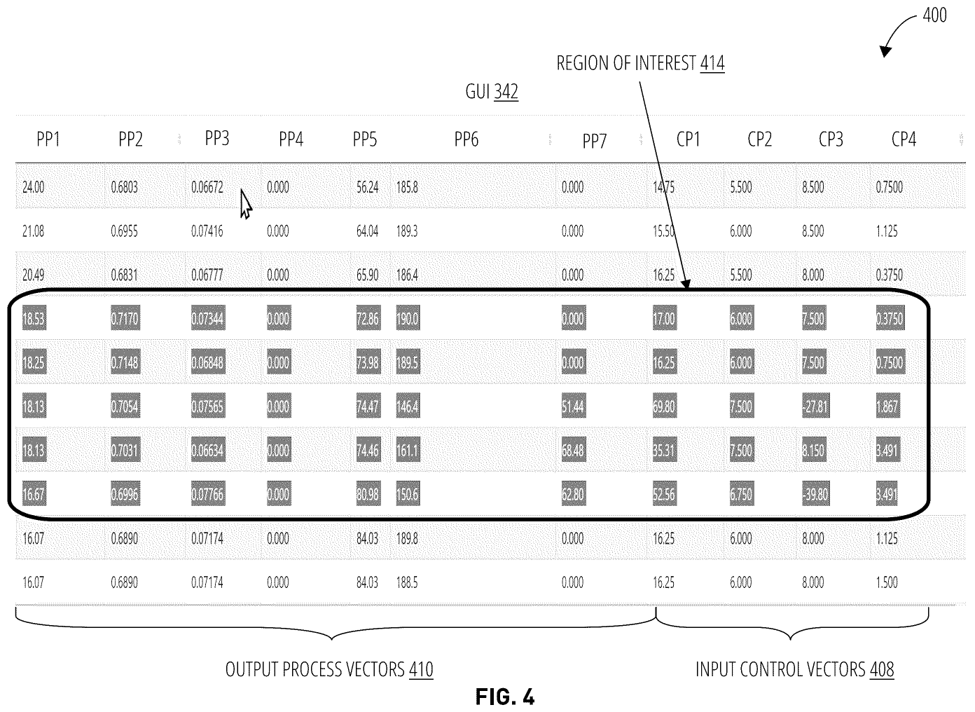

The model manager 322 generally manages various operations for one or more ML models 324. The ML models 324 have access to various parameters 332, including control parameters 334, process parameters 336, and qualifier parameters 338. The parameters 332 are stored in the memory 306 or in the settings database 340. In one embodiment, the ML models 324 present the control parameters 334, the process parameters 336 and/or the qualifier parameters 338 on the GUI 342 of an electronic display 344. An example of the GUI 342 is described with reference to FIG. 4.

An operator for the ion implanter 102 typically tunes components of the ion implanter 102 by modifying one or more control parameters 334 for the components to determine an effect on one or more process parameters 336 for the components. Each of the control parameters 334 corresponds to a hardware or software setting for a component of the ion implanter 102. Examples of control parameters 334 include without limitation a charge parameter, an energy parameter, an acceleration or deceleration parameter, a dopant and flow parameter, a diluent and flow parameter, a source parameter, an analyzer parameter, a corrector parameter, a suppression parameter, a focus parameter, a scan parameter, a quadrupole lens current parameter, a post-acceleration voltage parameter, and other control parameters. Embodiments are not limited to these examples. Each of the process parameters 336 corresponds to a metric associated with a beam property for an ion beam generated by the ion implanter 102. Examples of the process parameters 336 include a beam height parameter, a beam width parameter, full half height maximum (FHHM) parameter, a vertical within device angle (VWIDA) parameter, a VWIDA mean (VWIDAM) parameter, a horizontal within device angle (HWIDA) parameter, a HWIDA mean (HWIDAM) parameter, a standard deviation of VWIDA (VWIDAS) parameter, a standard deviation of HWIDA mean (HWIDAS) parameter, a vertical intensity (VI) parameter, a width parameter, a spotscore parameter, an energy parameter, a region of interest (ROI) current parameter, or a uniformity parameter.

Changing one or more control parameters 334 for one or more components of the ion implanter 102 affects a beam property of an ion beam as it implants ions into a substrate of a silicon wafer. In conventional systems, this is typically a manually-intensive process, where the operator manually changes values for control parameters 334 and evaluates changes in values for process parameters 336 important for a given application. This process continues in an iterative fashion until a particular configuration for the control parameters 334 produces the desired output values for the process parameters 336.

Embodiments automate tuning operations for the ion implanter 102 using one or more ML models 324 to avoid or reduce manual adjustments required by conventional systems. In general, a machine learning model is a mathematical representation or algorithmic structure that learns patterns and relationships from data in order to make predictions or take decisions without being explicitly programmed. It is a key component of machine learning, which is a subfield of artificial intelligence. A machine learning model is trained on a dataset containing input data and corresponding output labels or target values. During the training process, the model iteratively adjusts its internal parameters and learns from the data, aiming to minimize the difference between its predictions and the true values. Once trained, the model can be used to make predictions or decisions on new, unseen data. It takes the learned patterns and applies them to the input data to generate output predictions or estimates.

There are various types of machine learning models, each suited to different types of tasks and problem domains. Some common categories of machine learning models include: (1) regression models used to predict continuous numerical values, such as housing prices or stock prices; (2) classification models to classify inputs into different classes or categories based on their features, such as image classification or email spam filtering; (3) clustering models to group similar instances in an unsupervised manner, without prior knowledge of the classes or categories; (4) neural networks comprising interconnected nodes (or neurons) organized into layers, with each node applying functions to the data it receives; and (5) decision trees to represent decisions and their possible consequences as a tree-like structure and are commonly used for classification and regression tasks. These are just a few examples, and there are many other types and variations of machine learning models, each designed to tackle different types of problems and data structures.

As depicted in FIG. 3, the ML models 324 include a control model 326. In one embodiment, for example, the control model 326 is implemented as a feedforward model. A feedforward model is a type of neural network architecture where information flows through the network in one direction, from the input layer to the output layer, without any loops or cycles. It is called “feedforward” because the data passes through the network sequentially, layer by layer, without any feedback connections. In a feedforward model, the input data is fed into the input layer, and then it propagates forward through one or more hidden layers, where the data is transformed and processed. Finally, the transformed data is outputted by the output layer. Each layer is composed of multiple nodes (also called neurons) that perform calculations on the input data and apply linear or non-linear activation functions. The main purpose of a feedforward model is to map the input data to the desired outputs by learning the appropriate set of weights and biases associated with each node in the network. This learning process is typically accomplished through techniques such as backpropagation, where the model adjusts its parameters based on the difference between its predicted outputs and the ground truth labels. feedforward models are commonly used in various machine learning tasks, including classification, regression, and pattern recognition.

In one embodiment, the control model 326 is a feedforward model trained to receive an input control vector and predict an output process vector. An input control vector comprises an ordered list of values representing a set of control parameters 334 for the ion implanter 102. Each element of the input control vector corresponds to a specific value for each of the control parameters 334. The output process vector comprises an ordered list of values representing a set of process parameters 336 for the ion implanter 102 corresponding to the control parameters 334. Each element of the output process vector corresponds to a specific value for each of the process parameters 336.

The ML models 324 also include a saliency model 328. The saliency model 328 may implement one or more saliency techniques to support the control model 326. Examples of saliency techniques include without limitation layer-wise relevance propagation, gradient-based methods, Shapley additive explanations (SHAP), and other saliency techniques. Embodiments are not limited to these examples.

In general, saliency analysis in machine learning is a process used to determine the relative importance or relevance of various features or inputs that contribute to the decision-making of a model. It aims to shed light on which aspects of the input data have the most significant influence on the model's output or prediction. By quantifying the saliency, researchers and practitioners gain valuable insights into the inner workings of the model and can extract meaningful information about its behavior. Saliency analysis techniques often rely on gradient-based methods, such as gradient attribution or gradient-based class activation mapping (CAM). These methods calculate the gradient of the output with respect to the input features, indicating the direction and magnitude of sensitivity to changes in each feature. This gradient information can then be used to determine the saliency scores or importance rankings for different features. For example, in the context of image classification, suppose we have a deep convolutional neural network that can classify various objects. By applying saliency analysis, researchers can determine which regions of an image are most influential in the classification decision. The generated saliency map highlights the important regions, enabling an understanding of the model's focus and reasoning. In natural language processing, saliency analysis can be applied to assess the importance of words or phrases in text analysis tasks. By calculating the gradients of the output with respect to the input text, crucial words or phrases are identified that significantly affect the model's decision, such as in sentiment analysis or machine translation tasks. Overall, saliency analysis provides valuable insights into the internal mechanisms of machine learning models, helping researchers, developers, and analysis software better understand the decision-making process and improve the interpretability of the models.

Saliency seeks to understand which inputs to a neural network have the biggest impact on a particular output. It leverages a process very similar to backpropagation, where you follow the highest positive/negative weights, working backward through the network and in the end, ranking which inputs have the greatest impact on the outputs. Often these are used in image classifiers, such as Convolutional Neural Networks (CNNs). Such a process can show an image highlighted by content most strongly correlated with the classification. For example, a dog's face and neck are usually much more important than the legs and tail. Similarly, saliency can also be applied to regression as well, where the saliency model 328 applies a forward prediction to an actual observation vector, and works backward to find the inputs that are most correlated to those differences. In the case of the control model 326, the saliency model 328 can identify which controls are the most effective in moving the metrics from current to desired. Normally, which controls have authority over metrics varies significantly over the operational window of an ion implanter 102. The saliency model 328 can inform a tuning algorithm as to which controls to adjust, and in which direction, and which ones to leave fixed. Furthermore, if desired metrics identify multiple operational tool windows, then each of the operational windows can be evaluated using a saliency map and rank operational windows based on ability to control the metrics smoothly and independently.

The mathematics behind saliency analysis can appear straightforward, but in practice, there are difficulties involved. While the mathematical approach is similar to that used to learn via backpropagation, normal backpropagation uses a stochastic approach, relying on evaluation of many training pairs and making small adjustments with each group. Saliency, on the other hand, is tracing back one output vector gradient to one input vector gradient. Due to similar vanishing gradient issues or dead neurons (e.g., that are below activation), it can be hard to determine if the small gradient predicted on a particular input variable is because it has little to no effect on the output variable, or because it has great impact on the output (e.g., a 0.1% variation on the input results in a 2% change in output).

If a neural network is full of rectified linear unit (ReLU) activation functions, the back propagation may hit dead neurons. While this simplifies the analysis by creating a sparse network, a non-zero activation function like sigmoid makes it easier to interpret the direction of a correction. There are several different ways to do saliency analysis. However, the best approach can vary depending on the model. Saliency analysis helps to quickly reduce the set of all interactions to a set of probable interactions that impact the output variation being searched. These can be validated in forward direction. The output of the saliency predictions are tested using the scoring model 330, resulting in both scoring for general tunability and stability. In some cases, specific tunability scoring may need to be done at recipe development time in order to score those specific metrics that the operator wants to control. This is particularly useful when trying to distinguish between similar metric solutions for different control inputs

In one embodiment, for example, the saliency model 328 may perturb an input vector or an output vector of the control model 326 to find corresponding deviations in the input vector or the output vector. For example, the saliency model 328 may implement one or more saliency techniques for the control model 326 to determine how changes to one or more of the control parameters 334 impact the predicted process parameters 336. In another example, the saliency model 328 may also implement one or more saliency techniques for the control model 326 to determine how changes to one or more of the process parameters 336 impact the input control parameters 334. The saliency model 328 can assess a target correction value in current metrics and suggest a correction in the inputs in both direction and magnitude for each input to do a simultaneous correction to metrology.

The ML models 324 further include a scoring model 330. The scoring model 330 implements a scoring algorithm designed to test and score saliency predictions from the saliency model 328 to provide metrics for ion beam stability and ease of tune. This scoring can then be added as a new meta output to facilitate either control model inversion, where uniqueness is required, or as a user presented criterion to make informed choices.

A scoring algorithm for machine learning models is a mechanism used to assign scores or probabilities to different instances or data points based on their predicted outcomes. These algorithms provide a quantitative measure of confidence or likelihood of a particular prediction or classification made by the machine learning model. Scoring algorithms can vary depending on the specific task and model architecture. One example of scoring algorithms is probability estimation. Many machine learning models, such as logistic regression, support vector machines, or neural networks with softmax activation, can provide probability estimates as scores. These scores represent the likelihood of a particular class, ranging from 0 to 1, summing up to 1 across all possible classes. Another example of a scoring algorithm is a decision function. Some models, like support vector machines or decision trees, use a decision function to determine the score. The decision function returns a numerical value that can be used as a threshold for classifying instances. Positive values imply one class, while negative values suggest another. The magnitude of the value can also indicate the confidence level. Another example of a scoring algorithm is similarity measure. For tasks like recommendation systems or clustering, scoring algorithms can leverage similarity measures, such as cosine similarity or Euclidean distance. These measures assign scores based on the similarity between instances, with higher scores indicating greater likeness. Yet another example of a scoring algorithm is rank-based scoring. In certain scenarios, models may have a ranking objective, such as in search engine result ranking or recommendation systems. Scoring algorithms can be designed to assign ranks or scores based on the model's ranked preferences for each instance. A specific scoring algorithm depends on the specific problem, available data, and the model itself. The selected algorithm should align with the task's objectives and requirements, ensuring accurate and meaningful scoring for the machine learning models.

In one embodiment, for example, the scoring model 330 implements a scoring algorithm to score tunability of the ion implanter, such as how easy it is to tune components of the ion implanter. Tunability is associated with two main attributes: (1) linear response; and (2) orthogonally of control which consider for each metric being controlled there is one control input that has a majority of the impact. To score tunability, for example, the scoring model 330 implements a figure of merit (FOM) with a tune score. For example, the scoring model 330 considers some factor for linearity, such as an R² fit coefficient over a defined variation (e.g., +/−2%). The scoring model 330 considers orthogonality as a function of a normalized impact factor of each control input. In one embodiment, for example, a suitable FOM formula may be represented as R²*(Primary Control Factor-Summarization Other Control Inputs).

In one embodiment, for example, the scoring model 330 implements a scoring algorithm to score vector predictability and stability. Because the scoring model 330 uses a saliency approach to determine an input correction vector to correct an output metric variation, the scoring model 330 assesses the accuracy of the saliency prediction for each controlled metric in turn. This can be a root mean square error (RSME) between the delta applied to the metric, and the round trip (Saliency+Forward test) prediction of the output. The saliency model 328 then runs the same vector through in forward mode but with +2X and −2X scaling to see how well the predicted forward vector varies. This helps identify regions of nonlinear behavior or cross control learned in the control model 326, where values may be near highly weighted neuron activation thresholds. This can be measured with a normalization of every output vector variation and doing an RSME comparison among the normalized vectors.

When operating together, the control model 326, the saliency model 328, and the scoring model 330 combine to form an inverted control model 348. The inverted control model 348 is the reverse of the control model 326. The inverted control model 348 receives as input a set of process parameters 336 and predicts a set of control parameters 334 that when applied to components of the ion implanter 102 produce an ion beam with beam properties or characteristics that match the process parameters 336. Although the device 302 includes a separate control model 326, saliency model 328 and scoring model 330, it may be appreciated that these ML models 324 can be combined into a single model. This is a design consideration based on expected performance of separate models versus a blended model.

In one embodiment, the settings manager 320 may configure a component of the ion implanter 102 based on the set of control parameters 334 scored by the scoring model 330. For example, the settings manager 320 can present the set of control parameters 334 on the GUI 342 for review and approval by an operator. The operator can select a GUI element representing approval of the proposed control parameters 334. The GUI 342 generates a control directive and sends it to the settings manager 320. The settings manager 320 then automatically configures the appropriate components with the approved control parameters 334. Alternatively, the settings manager 320 may be configured to automatically update the appropriate components with the proposed control parameters 334 without explicit approval. Embodiments are not limited in this context.

In one embodiment, the settings manager 320 may write the control parameters 334 to memory for software controllers of components of the ion implanter 102 or send control signals to hardware controllers for the components of the ion implanter 102. The ion implanter 102 may generate an ion beam based on the configured control parameters 334.

FIG. 4 illustrates an operating environment 400. The operating environment 400 illustrates an example of the GUI 342 for the device 302.

In one embodiment, for example, a software application such as the settings manager 320 and/or the model manager 322 may comprise instructions suitable for execution by logic circuitry or processing circuitry 304 of the device 302. The software application is generally arranged to assist in tuning operations for an ion implanter 102. The software application includes a GUI 342 to present multiple GUI elements representing a set of control parameters 334 for an ion implanter 102, with each of the control parameters 334 having an associated information field to present one or more values for each of the control parameters 334. A control parameter generally corresponds to a hardware or software setting that controls a particular configuration or operation of a component of the ion implanter 102. The GUI 342 also presents multiple GUI elements representing a set of process parameters 336 for the ion implanter 102, with each of the process parameters 336 having an associated information field to receive configurable values for each of the process parameters 336. A process parameter generally corresponds to a beam property, or a metric associated with a beam property, for an ion beam generated by the ion implanter 102.

An operator may use the GUI to select or enter defined threshold values in the information fields associated with process parameters 336 of interest to the operator, referred to herein as a target set of process parameters. The software application implements one or more ML models 324 as the inverted control model 348 trained to accept as input the target set of process parameters 336 and associated values, such as the control model 326, the saliency model 328, and the scoring model 330, or some combination thereof. The inverted control model 348 makes a prediction or inference for a set of control parameters 334 and associated values that when applied to various components of the ion implanter 102 produces an ion beam with beam properties that match the target set of process parameters 336. This provides a significant technical advantage over conventional techniques, since the operator does not need to manually and repetitively adjust control parameters 334 in an attempt to arrive at a desired set of beam properties for a given application.

As depicted in FIG. 4, the GUI 342 presents an example for a region of interest 412 comprising an example of input control vectors 408 and an example of output process vectors 410 of the ML models 324. By way of example, assume an operator desires to have the ion implanter generate an ion beam consistent with process parameters 336 having values above a set of defined threshold values, such as a process parameter (PP) 1 (PP1) of 17.5 mm, a PP2 of 0.7, and a PP3 of 0.07 (or better). Further assume the operator uses the GUI 342 for the settings manager 320 to select an input control vector with values for four control parameters, such as a control parameter (CP) 1 (CP1) of 52.56 kilovolts (kV), a CP2 of 6.750 kV, a CP3 of −39.80, and a CP4 of 3.491 kV. The control model 326 may generate and display an output process vector with metrology for beam properties corresponding to the input control vector, such as a PP1 of 16.67, a PP2 of 0.6996, a PP3 of 0.07766, a PP4 of 0.000, a PP5 of 80.98, a PP6 of 150.6 mm, and a PP7 of 0.000. While the PP3 of 0.7760 meet the defined threshold value, the PP1 of 16.67 and PP2 of 0.6996 are below the defined threshold values. As such, the operator must manually and repeatedly adjust one or more values of the four control parameters until the beam property threshold values are all exceeded for the process parameters. This is a typically a tedious and time-consuming task for the operator, particularly when there is a large number of control parameters and process parameters.

The GUI 342 illustrates 5 different sets of input values for different input control vectors 408 that result in 5 different sets of output values for different output process vectors 410. The scoring model 330 may score the 5 different set of input control vectors 408, and recommend one of the input control vectors 408 based on the scores, such as a highest score representing a global optima search region for the output process vectors 410, for example.

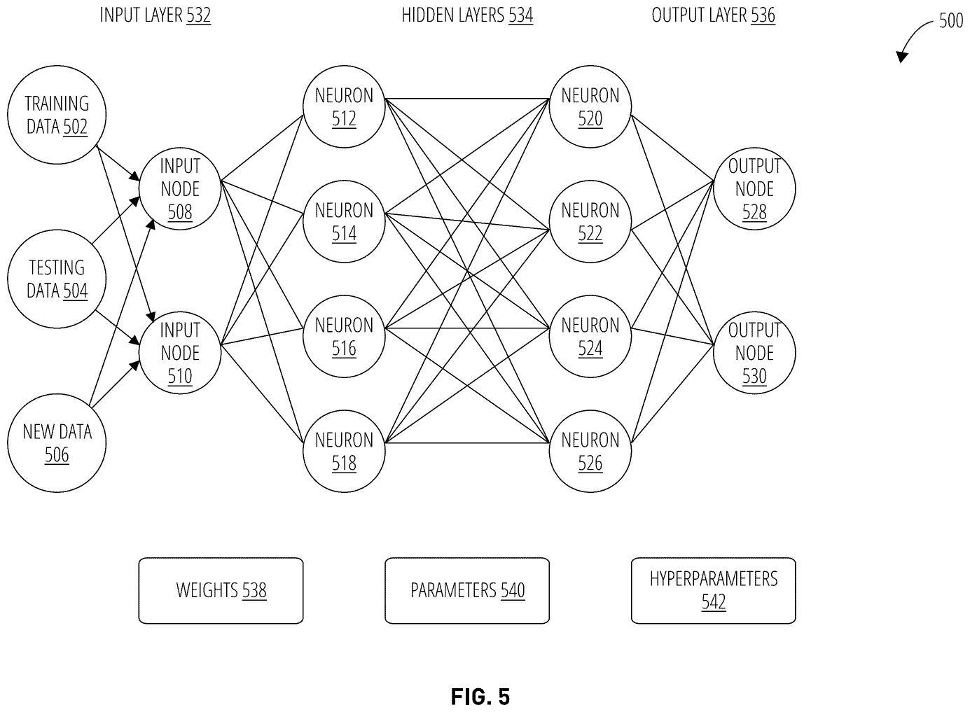

FIG. 5 illustrates an embodiment of an artificial neural network 500. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 500 comprises multiple node layers, containing an input layer 532, one or more hidden layers 534, and an output layer 536. Each layer comprises one or more nodes. As depicted in FIG. 5, for example, the input layer 532 has input node 508 and input node 510. The artificial neural network 500 has two hidden layers 534, with a first hidden layer having neuron 512, neuron 514, neuron 516 and neuron 518, and a second hidden layer having neuron 520, neuron 522, neuron 524 and neuron 526. The artificial neural network 500 has an output layer 536 with output node 528 and output node 530. Each node or neuron comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 500 relies on training data 502 to learn and improve accuracy over time. However, once the artificial neural network 500 is fine-tuned for accuracy, and tested on testing data 504, the artificial neural network 500 is ready to classify and cluster new data 506 at a high velocity. Tasks in speech recognition, image recognition, or calculating continuous values can take minutes versus hours when compared to the manual identification by human experts.

The artificial neural network 500 is a linear regression model, composed of input data, weights, a bias (or threshold), and an output. Once an input layer 532 is determined, a set of weights 538 are assigned. The weights 538 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 500 as a feedforward network.

In one embodiment, the artificial neural network 500 leverages sigmoid neurons, which are distinguished by having values between 0 and 1. Since the artificial neural network 500 behaves similarly to a decision tree, cascading data from one node to another, having x values between 0 and 1 will reduce the impact of any given change of a single variable on the output of any given node, and subsequently, the output of the artificial neural network 500.

The artificial neural network 500 has many practical use cases, like image recognition, speech recognition, text recognition or classification. The artificial neural network 500 leverages supervised learning, or labeled datasets, to train the algorithm. As the model is trained, its accuracy is measured using a cost (or loss) function. This is also commonly referred to as the mean squared error (MSE).

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 540 of the model adjust to gradually converge at the minimum.

In one embodiment, the artificial neural network 500 is feedforward, meaning it flows in one direction only, from input to output. In one embodiment, the artificial neural network 500 uses backpropagation. Backpropagation is when the artificial neural network 500 moves in the opposite direction from output to input. Backpropagation allows calculation and attribution of errors associated with each neuron, thereby allowing adjustment to fit the parameters 540 of the ML model 1002 appropriately.

The artificial neural network 500 is implemented as different neural networks depending on a given task. Neural networks are classified into different types, which are used for different purposes. In one embodiment, the artificial neural network 500 is implemented as a feedforward neural network, or multi-layer perceptrons (MLPs), comprised of an input layer 532, hidden layers 534, and an output layer 536. While these neural networks are also commonly referred to as MLPs, they are actually comprised of sigmoid neurons, not perceptrons, as most real-world problems are nonlinear. Trained data 1104 usually is fed into these models to train them, and they are the foundation for computer vision, natural language processing, and other neural networks. In one embodiment, the artificial neural network 500 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 500 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 500 is implemented as any type of neural network suitable for a given operational task of inferencing system 300, and the MLP, CNN, and RNN are merely a few examples. Embodiments are not limited in this context.

The artificial neural network 500 includes a set of associated parameters 540. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 500 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 542. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

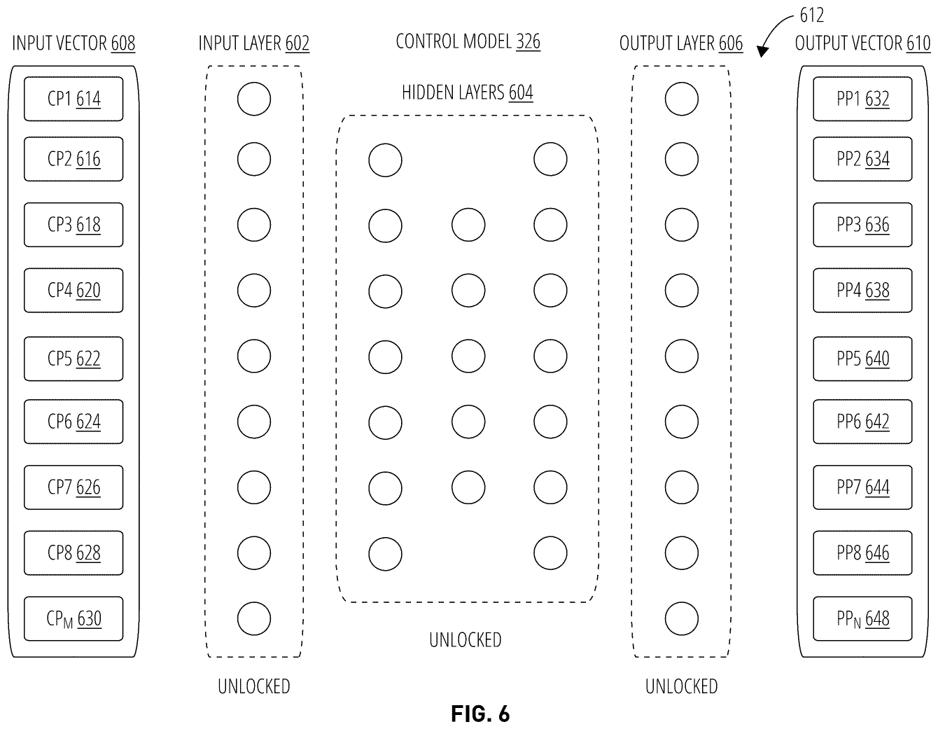

FIG. 6 illustrates an example of ML model 612 implemented as an artificial neural network 500. Specifically, the ML model 612 is an example of the control model 326 having an input layer 602, an output layer 606, and multiple hidden layers 604. The control model 326 is a feedforward network designed to accept as input an input vector 608 of control parameters 334 and predict an output vector 610 of process parameters 336.

As previously described, the inferencing system 300 implements AI/ML techniques for controlling a configuration or operation of an ion implanter 102. The inferencing system 300 automatically tunes one or more components of the ion implanter 102 for directing, controlling and shaping an ion beam as it travels from an ion source to a target material, such as a silicon wafer. The inferencing system 300 implements a control model 326, a saliency model 328, and a scoring model 330 as an inverted control model 348 for determining priority of control input tuning and calibration. The saliency model 328 implements saliency techniques analyze perturbations to the control model 326 implemented as a DNN to assess stability, ease of tuning, and prioritizing and/or restricting which controls are used and in which direction they are applied to optimize ion beam characteristics or properties in the ion implanter 102.

The ML model 612 is an example of a control model 326 implemented as an artificial neural network 500, such as a DNN, for example. The control model 326 may comprise an input layer 602, an output layer 606, and multiple hidden layers 604, where each layer comprises multiple neurons. The input layer 602 of the control model 326 receives an input vector 608 and generates an output vector 610.

The input vector 608 may comprise one or more control parameters 334, such as CP1 614 to CPM 630. Each of the control parameters 334 of the input vector 608 may represent a control parameter for various components of the ion implanter 102, such as nitrogen bleed flow standard cubic centimeters per minute (SCCM), manipulator X, Y, Z millimeters (mm), quadrapole magnet, dipole amplifiers, post scan suppression kilovolts (KV), scanner offset KV, focus KV, and so forth.

The output vector 610 may comprise one or more process parameters 336, such as PP1 632 to PPx 648. Each of the process parameters 336 of the output vector 610 may represent a beam property or metric, such as beam mean Y, center offset X, beam width, beam height, HWIDAM, HWIDAS, VWIDAM, VWIDAS, FHHM, ROI current, and so forth.

During training of the control model 326, the input layer 602, the output layer 606, and the multiple hidden layers 604 all remain unlocked. The input vector 608 and the output vector 610 comprise datapoints from a training dataset, such as training data 502, for example. This allows each layer to train through backpropagation learning. As the control model 326 processes the training data 502, backpropagation is used to adjust all weights and biases in the control model 326. Once trained, the control model 326 is tested using a testing dataset, such as testing data 504, for example.

Once trained and tested, the control model 326 may be deployed to begin inferencing operations on new datasets, such as new data 506, for the inferencing system 300. For example, an operator may use the GUI 342 to select or enter defined threshold values in the information fields associated with control parameters 334 of interest to the operator, referred to herein as a target set of control parameters 334. The software application implements the control model 326 trained to accept as input the target set of control parameters 334 and associated values, and the control model 326 makes a suggestion, prediction or inference for a set of process parameters 336.

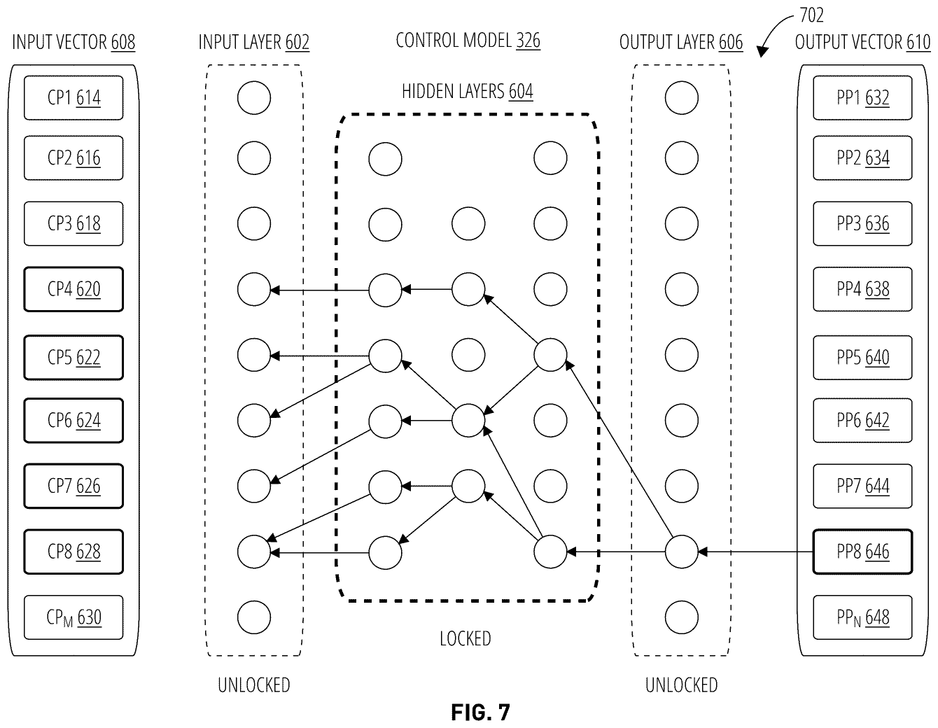

FIG. 7 illustrates an example of ML model 702 implemented as an artificial neural network 500. Specifically, the ML model 702 is an example of a saliency model 328. The saliency model 328 is a copy of the trained control model 326 as depicted in FIG. 6. As with the control model 326, the saliency model 328 comprise an input layer 602, an output layer 606, and multiple hidden layers 604. The control model 326 is a feedforward network designed to accept as input an input vector 608 of control parameters 334 and predict an output vector 610 of process parameters 336.

As previously described, the inferencing system 300 implements AI/ML techniques for controlling a configuration or operation of an ion implanter 102. The inferencing system 300 automatically tunes one or more components of the ion implanter 102 for directing, controlling and shaping an ion beam as it travels from an ion source to a target material, such as a silicon wafer. The inferencing system 300 implements a control model 326, a saliency model 328, and a scoring model 330 that operates as an inverted control model 348 for determining priority of control input tuning and calibration. The saliency model 328 implements saliency techniques analyze perturbations to the control model 326 implemented as a DNN to assess stability, ease of tuning, and prioritizing and/or restricting which controls are used and in which direction they are applied to optimize ion beam characteristics or properties in the ion implanter 102.

The inverted control model 348 of the inferencing system 300 determines a priority of control input tuning and calibration. For example, the saliency model 328 analyzes the control model 326 to identify stability (e.g., mapping variation on input to impact on metrics) and tunability (e.g., mapping variation of a specific metric to a set of inputs) and uses these criteria to choose which tuning windows to prioritize. In a forward direction, the saliency model 328 analyzes how one or more input control vectors 408 impact multiple output process vectors 410. In a backward direction, the saliency model 328 analyzes how one or more output process vectors 410 are impacted by multiple input control vectors 408 and which control parameters 334 are affected by process parameters 336.

The saliency model 328 estimates an impact of tuning controls for the ion implanter 102. For example, the saliency model 328 analyzes a difference in a measured output to a target output, and it determines what changes to control parameters 334 are most likely to correct the measured process parameters 336 back to the target output. Specifically, the saliency model 328 assesses a desired correction value in current metrics and suggests a correction in the inputs in both direction and magnitude for each input to do a simultaneous correction to metrology. For example, small variations are made to one or more of the outputs at a known location. Small perturbations are used for both: (1) finding a correction to the inputs to correct an output to the desired value; and (2) for assessing which inputs are associated with a change to a single output variable and in what proportion.

The saliency model 328 performs a saliency analysis to attribute variations on an output vector 610 to variations on an input vector 608 for the control model 326. The input vector 608 may comprise one or more control parameters 334, such as CP1 614 to CPM 630. The output vector 610 may comprise one or more process parameters 336, such as PP1 632 to PPN 648. This is done in a similar fashion to backpropagation learning. However, rather than using the data to adjust all weights and biases in the control model 326, the hidden layers 604 are locked to fix the weights and biases of the hidden layers 604. The input layer 602 and the output layer 606 remain unlocked so that the saliency model 328 can measure a net change on the input vector 608. For example, to analyze sensitivity in the control model 326), the saliency model 328 perturbs one or more control parameters 334 of the input vector 608, and it analyzes changes on the process parameters 336 (e.g., the metrics). Additionally or alternatively, the saliency model 328 may correct one or more process parameters 336 back to target values for a given application or recipe. This gradient “repair” to the output vector 610 is worked back through the saliency model 328, and the saliency model 328 analyzes a most likely gradient change on the input vector 608. This approach greatly speeds up the search for determining what changes are needed for the input vector 608 to make the target changes to the output vector 610. This approach can be used to assess tunability (e.g., orthogonality of inputs to outputs), stability (e.g., strong weights on inputs that can vary), or suggest changes to inputs to correct outputs. Because of its ability to score tunability and stability, it can be used to facilitate the inversion of the model by removing duplicate output vectors. In this manner, using a control model 326 in combination with a saliency model 328 may effectively allow the control model 326 to operate as an inverted control model 348.

For example, an operator may use the GUI 342 to select or enter defined threshold values in the information fields associated with process parameters 336 of interest to the operator, referred to herein as a target set of process parameters. The software application implements the ML models 324 trained to accept as input the target set of process parameters 336 and associated values, and the ML models 324 make a suggestion, prediction or inference for a set of control parameters 334 and associated values that when applied to various components of the ion implanter 102 produces an ion beam with beam properties that match the target set of process parameters 336. The scoring model 330 may automatically score the predicted changes to the input vector 608. The scoring can then be, and it can select or recommend a predicted change based on different scoring criteria, such as stability, tunability, and other criteria.

Additionally, or alternatively, the ML model may recommend a single step, multivariate change. The ML models 324 speed up sensitivity analysis to better score stability and ease of tune. This provides a significant technical advantage over conventional techniques, since the operator does not need to manually and repetitively adjust control parameters 334 in an attempt to arrive at a set of process parameters 336 with the desired set of beam properties for a given application.

As depicted in FIG. 6, the saliency model 328 performs a saliency analysis to attribute variations on an output vector 610 to variations on an input vector 608 for the control model 326. The input vector 608 may comprise one or more control parameters 334, such as CP1 614 to CPM 630. Each of the control parameters 334 of the input vector 608 may represent a control parameter for various components of the ion implanter 102, such as nitrogen bleed flow standard cubic centimeters per minute (SCCM), manipulator X, Y, Z millimeters (mm), quadrapole magnet, dipole amplifiers, post scan suppression kilovolts (KV), scanner offset KV, focus KV, and so forth. The output vector 610 may comprise one or more process parameters 336, such as PP1 632 to PPN 648. Each of the process parameters 336 of the output vector 610 may represent a beam property or metric, such as beam mean Y, center offset X, beam width, beam height, HWIDAM, HWIDAS, VWIDAM, VWIDAS, FHHM, ROI current, and so forth.

The saliency model 328 or an operator may change one of the process parameters 336 of the output vector 610 to analyze changes to the control parameters 334 of the input vector 608. The magnitude of the changes may be configurable. However, smaller perturbations will allow analysis of fine-grained changes to the input vector 608. Small perturbations can be used for both finding a correction to the inputs to correct an output to the desired value and for assessing which inputs are associated with a change to a single output variable and in what proportion.

The changes to the process parameters 336 may represent tuning of an old recipe to a target set of process parameters 336 for an existing application or tuning a new recipe for a new application, for example. The former case may represent when a measured metrology fails to match a target metrology, and the saliency model 328 or the operator changes one or more of the process parameters 336 to match the target metrology. In some cases, the saliency model 328 will be unable to give process values for the control parameters 334 that match the precise metrology values for the process parameters 336. In such cases, however, the saliency model 328 may provide at least a region of interest for the control parameters 334 for further analysis or present criterion to allow the operator to make informed choices via the GUI 342. Furthermore, if desired metrics in the inverted control model 348 identifies multiple operational tool windows, then each of the operational windows can be evaluated using the saliency model 328 and the model manager 322 may rank operational windows based on ability to control the metrics smoothly and independently.

By way of example, assume the saliency model 328 changes a value for PP8 646 corresponding to a FHHM metric by 2%. Through backpropagation, the control model 326 updates weights and biases for neurons in the control model 326. However, since the hidden layers 604 are locked, only the weights and biases for the unlocked layers, input layer 532 and output layer 606, are updated. The result of backpropagation is a change in values for CP4 620, CP5 622, CP6 624, CP7 626, and CP8 628 of the input vector 608 such as 0.2%, 0.5%, 0.2%, 1%, and 2%, respectively. The saliency model 328 analyzes the changes to the input vector 608, and determine that CP8 628 corresponding to a focus KV control has the greatest amount of change of 2% when the FHHM metric is changed by 2%. The scoring model 330 may score the changes to the control parameters 334 of the input vector 608. The saliency model 328 then changes another of the process parameters 336, and repeats this process until a terminating condition is reached. Examples of terminating conditions might be a number of process parameters 336, a hyperparameter for a number of epochs, a time limit, a vanishing gradient of changes, and so forth.

This process continues to rotate through the process parameters 336 until a terminating condition is met. In one embodiment, for example, the saliency model 328 may be designed to only perturb the primary process parameters 336 for evaluation to capture the major changes to the control parameters 334. Once the terminating condition is met, and all the changes to the input vector 608 are scored, the model manager 322 of the inferencing system 300 may recommend a set of control parameters 334 that can be used to configure an ion implanter 102 to generate an ion beam with the target process parameters 336.

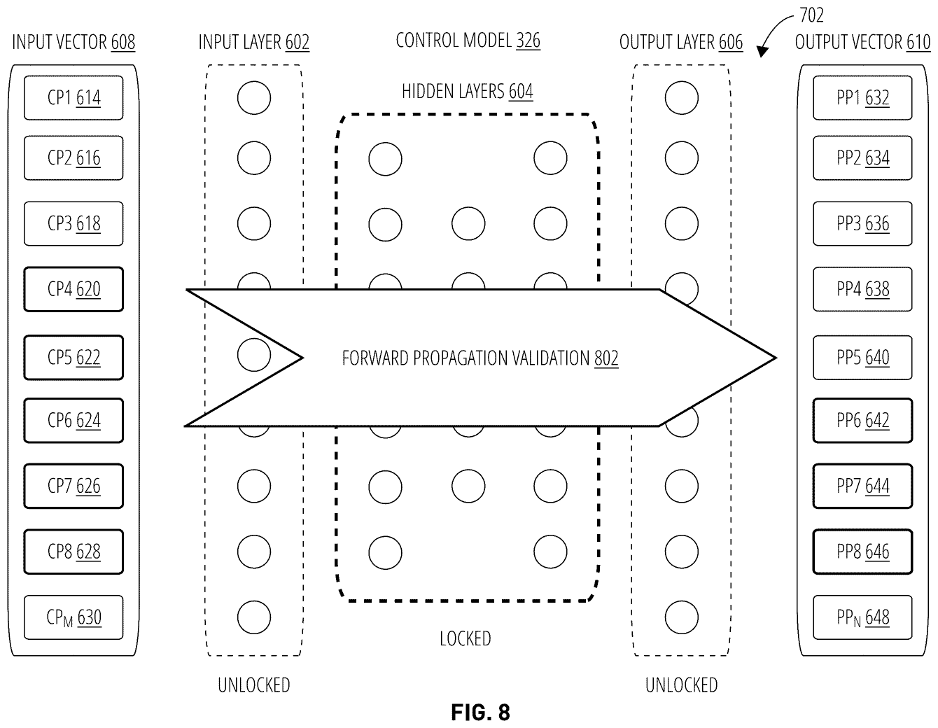

FIG. 8 illustrates an example of ML model 612 implemented as an artificial neural network 500. Specifically, the ML model 612 is an example of the control model 326 having an input layer 602, an output layer 606, and multiple hidden layers 604. The control model 326 is a feedforward network designed to accept as input an input vector 608 of control parameters 334 and predict an output vector 610 of process parameters 336.

Once the saliency model 328 rotates through tuning the process parameters 336, and the scoring model 330 scores the changes to the control parameters 334, a validation process may be implemented to validate recommendations made by the saliency model 328. Because the saliency model 328 estimates corrections to the input vector 608 to correct variations made to the output vector 610, the model manager 322 may assess the accuracy of the saliency predictions for each controlled metric in turn.

As previously described, the scoring model 330 may implement a scoring algorithm to score tunability of the ion implanter, such as how easy it is to tune components of the ion implanter. Tunability is associated with two main attributes: (1) linear response; and (2) orthogonally of control which consider for each metric being controlled there is one control input that has a majority of the impact. To score tunability, for example, the scoring model 330 implements a figure of merit (FOM) with a tune score. For example, the scoring model 330 considers some factor for linearity, such as an R² fit coefficient over a defined variation (e.g., +/−2%). The scoring model 330 considers orthogonality as a function of a normalized impact factor of each control input. In one embodiment, for example, a suitable FOM formula may be represented as R²*(Primary Control Factor-Summarization Other Control Inputs).

Additionally, or alternatively, the scoring model 330 may implement a scoring algorithm to score vector predictability and stability. Because the scoring model 330 uses a saliency approach to determine an input correction vector to correct an output metric variation, the scoring model 330 assesses the accuracy of the saliency prediction for each controlled metric in turn. This can be a root mean square error (RSME) between the delta applied to the metric, and the round trip (Saliency+Forward test) prediction of the output. The saliency model 328 then runs the same vector through in forward mode but with +2X and −2X scaling to see how well the predicted forward vector varies. This helps identify regions of nonlinear behavior or cross control learned in the control model 326, where values may be near highly weighted neuron activation thresholds. This can be measured with a normalization of every output vector variation and doing an RSME comparison among the normalized vectors.

In either case, the saliency model 328 may perform forward propagation validation 802 to validate the estimates provided by the saliency model 328 using forward propagation. In one embodiment, the forward propagation validation 802 may provide an additional confidence level for the predictions made by the saliency model 328 since the predictions made by the saliency model 328 are estimates. Depending on a configuration for the scoring model 330, such as for scoring ease of tune or vector predictability and stability, the saliency model 328 can run a predicted vector through in forward mode with some scaling factor, such as +2X and −2X scaling or some other scaling factor, to determine how well the predicted forward vector varies.

As depicted in FIG. 8, for example, the control parameters 334 for the input vector 608 may be changed to the estimated values from the saliency model 328. Continuing with the previous example, the saliency model 328 changes values for CP4 620, CP5 622, CP6 624, CP7 626, and CP8 628 of the input vector 608 such as 0.2%, 0.5%, 0.2%, 1%, and 2%, respectively. The saliency model 328 predicts the output vector 610 with changed values for PP6 642, PP7 644, and PP8 646 of 0.1%, 0.2%, and 2%, respectively. Since the saliency model 328 only changed the PP8 646 representing the FHHM metric by 2%, the forward propagation validation 802 by the saliency model 328 validates that the changes to the control parameters 334 also affect other process parameters 336, namely PP6 642 and PP7 644, for example. By using forward propagation validation 802, the model manager 322 or the operator may quickly determine whether the predicted changes to the control parameters 334 are desired for a given recipe.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

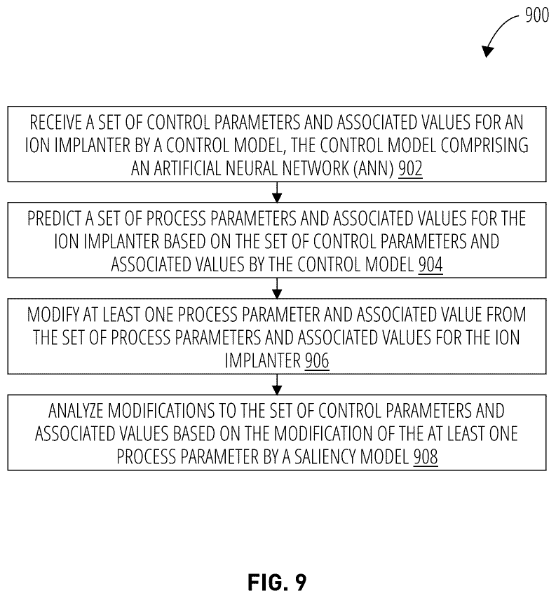

FIG. 9 illustrates an embodiment of a logic flow 900. The logic flow 900 may be representative of some or all of the operations executed by one or more embodiments described herein. For example, the logic flow 900 may include some or all of the operations performed by devices or entities within the inferencing system 300, the training system 1100, the device 302, or the training device 1016. More particularly, the logic flow 900 illustrates an example where the device 302 performs inferencing operations for one or more of the ML models 324.

In block 902, logic flow 900 receives a set of control parameters and associated values for an ion implanter by a control model, the control model comprising an artificial neural network (ANN). In block 904, logic flow 900 predicts a set of process parameters and associated values for the ion implanter based on the set of control parameters and associated values by the control model. In block 906, logic flow 900 modifies at least one process parameter and associated value from the set of process parameters and associated values for the ion implanter. In block 908, logic flow 900 analyzes modifications to the set of control parameters and associated values based on the modification of the at least one process parameter by a saliency model.

By way of example, with reference to the inferencing system 300 and the ML models 324, the control model 326 receives a set of control parameters 334 and associated values for an ion implanter 102. The control model 326 includes an artificial neural network 500. The control model 326 predicts a set of process parameters 336 and associated values for the ion implanter 102 based on the set of control parameters 334 and associated values by the control model 326. The saliency model 328 modifies at least one of the process parameters 336 and associated value from the set of process parameters 336 and associated values for the ion implanter 102. The saliency model 328 analyzes modifications to the set of control parameters 334 and associated values based on the modification of the at least one of the process parameters 336. This process may be repeated for some or all of the process parameters 336 to analyze changes to the control parameters 334.

In one embodiment, for example, the saliency model 328 is a copy of the control model 326, and it includes an input layer 602, an output layer 606, and multiple hidden layers 604. The multiple hidden layers 604 are locked so that weights and biases of neurons for the locked multiple hidden layers 604 cannot be changed. The input layer 602 and the output layer 606 remain unlocked so that weights and biases of neurons for the unlocked input layer 602 and the unlocked output layer 606 can be changed.

In one embodiment, for example, a scoring model 330 may score the modifications to the set of control parameters 334 and associated values. For example, the scoring model 330 may score the modifications to the set of control parameters 334 and associated values, where the scoring model 330 generates a score for ease of tuning components of the ion implanter 102 or a score for stability of tuning components of the ion implanter 102. The scoring model 330 or the model manager 322 may recommend a modified set of control parameters 334 and associated values based on a score associated with the modified set of control parameters 334.

In one embodiment, for example, the saliency model 328 may validate the modifications to the set of control parameters 334 and associated values using forward propagation validation 802.

In one embodiment, for example, the model manager 322 may present a modified set of control parameters 334 and associated values on a GUI 342 of an electronic display.

In one embodiment, for example, the settings manager 320 may automatically configure a component of the ion implanter 102 based on a modified set of control parameters 334.

In one embodiment, for example, the settings manager 320 may automatically cause the ion implanter 102 to generate an ion beam based on the modified set of control parameters 334.

FIG. 10 illustrates an apparatus 1000. The apparatus 1000 depicts a training device 1016 suitable to generate a trained ML model 1002 for an inferencing device, such as the device 302 of the inferencing system 300. In one embodiment, the training device 1016 executes various ML components 1012 to generate an ML model 1002, such as a control model 326, a saliency model 328 and/or a scoring model 330 by performing various training, testing, and validation operations.

As depicted in FIG. 10, the training device 1016 includes a processing circuitry 1018 and a set of ML components 1012 to support various AI/ML techniques, such as a data collector 1004, a model trainer 1006, a model evaluator 1008 and a model inferencer 1010.

In general, the data collector 1004 collects data 1014 from one or more data sources to use as training data for the ML model 1002. The data collector 1004 collects different types of data 1014, such as text information, audio information, image information, video information, graphic information, and so forth. The model trainer 1006 receives as input the collected data and uses a portion of the collected data as test data for an AI/ML algorithm to train the ML model 1002. The model evaluator 1008 evaluates and improves the trained ML model 1002 using a portion of the collected data as test data to test the ML model 1002. The model evaluator 1008 also uses feedback information from the deployed ML model 1002. The model inferencer 1010 implements the trained ML model 1002 to receive as input new unseen data, generate one or more inferences on the new data, and output a result such as an alert, a recommendation or other post-solution activity.

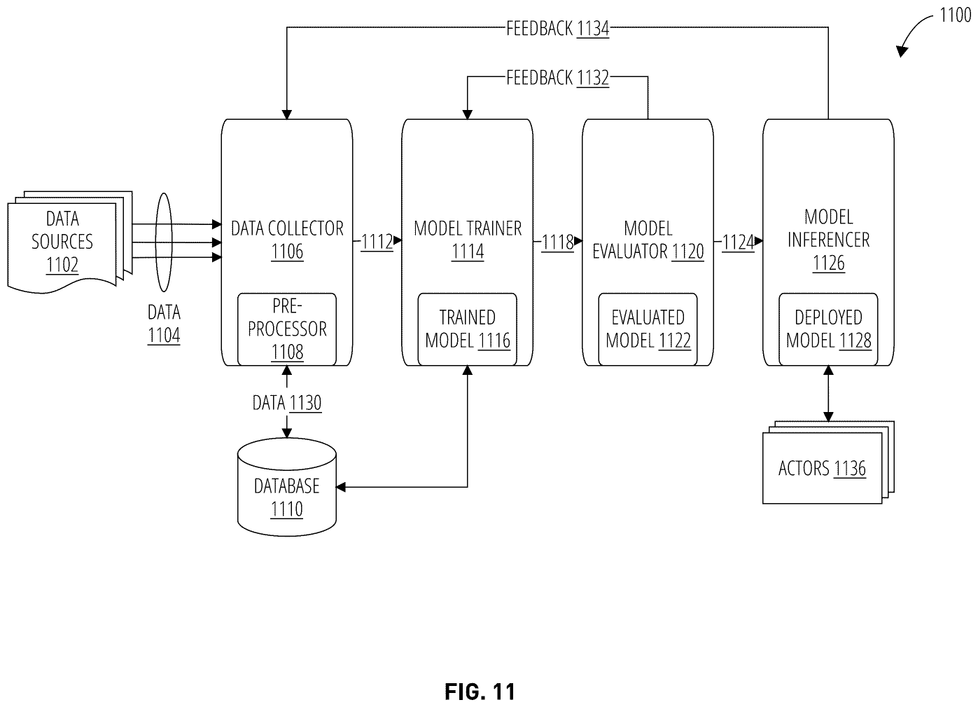

An exemplary AI/ML architecture for the ML components 1012 is described in more detail with reference to FIG. 11.

FIG. 11 illustrates a training system 1100. The training system 1100 is an example of a system suitable for implementing various artificial intelligence (AI) techniques and/or machine learning (ML) techniques to perform various tasks. AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the training system 1100 may include various machine or computer components (e.g., circuit, processor circuit, memory, network interfaces, compute platforms, input/output (I/O) devices, etc.) for an AI/ML system that are designed to work together to create a pipeline that can take in raw data, process it, train a ML model, evaluate its performance, deploy it in a production environment, and continuously monitor and maintain it.

A ML model is a mathematical construct used to predict outcomes based on a set of input data. ML models are trained using large volumes of data, and they can recognize patterns and trends in that data to make accurate predictions. The ML models are derived from different ML algorithms. The ML algorithms may comprise supervised algorithms, unsupervised algorithms, or semi-supervised algorithms.

A supervised algorithm is a type of machine learning algorithm that uses labeled data to train a model. In supervised learning, the algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will churn or not; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The training system 1100 may implement various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include an artificial neural network (ANN), convolutional neural network (CNN), deep learning, decision tree learning, support-vector machine, regression analysis, Bayesian networks, genetic algorithms, federated learning, distributed artificial intelligence, and various other ML algorithms.

As depicted in FIG. 11, the training system 1100 includes a set of data sources 1102 to source data 1104 for the training system 1100. Data sources 1102 may comprise any device capable generating, processing, storing or managing data 1104 suitable for a ML system. Examples of data sources 1102 include without limitation databases, web scraping, sensors and Internet of Things (IoT) devices, image and video cameras, audio devices, text generators, publicly available databases, private databases, and many other data sources 1102. The data sources 1102 may be remote from the training system 1100 and accessed via a network, local to the training system 1100 an accessed via a network interface, or may be a combination of local and remote data sources 1102.

The data sources 1102 may source difference types of data 1104. For instance, the data 1104 may comprise structured data from relational databases, such as customer profiles, transaction histories, or product inventories. The data 1104 may comprise unstructured data from websites such as customer reviews, news articles, social media posts, or product specifications. The data 1104 may comprise data from temperature sensors, motion detectors, and smart home appliances. The data 1104 may comprise image data from medical images, security footage, or satellite images. The data 1104 may comprise audio data from speech recognition, music recognition, or call centers. The data 1104 may comprise text data from emails, chat logs, customer feedback, news articles or social media posts. The data 1104 may comprise publicly available datasets such as those from government agencies, academic institutions, or research organizations. These are just a few examples of the many sources of data that can be used for ML systems. It is important to note that the quality and quantity of the data is critical for the success of a machine learning project.

The data 1104 can be in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1102 may be communicatively coupled to a data collector 1106. The data collector 1106 gathers relevant data 1104 from the data sources 1102. Once collected, the data collector 1106 may use a pre-processor 1108 to make the data 1104 suitable for analysis. This involves data cleaning, transformation, and feature engineering. Data preprocessing is a critical step in ML as it directly impacts the accuracy and effectiveness of the model. The pre-processor 1108 may receive the data 1104 as input, process the data 1104, and output pre-processed data 1130 for storage in a database 1110. The database 1110 may comprise a hard drive, solid state storage, and/or random access memory.

The data collector 1106 may be communicatively coupled to a model trainer 1114. The model trainer 1114 performs AI/ML model training, validation, and testing which may generate model performance metrics as part of the model testing procedure. The model trainer 1114 may receive the pre-processed data 1130 as input 1112 or via the database 1110. The model trainer 1114 may implement a suitable ML algorithm to train an ML model on the pre-processed data 1130. The training process involves feeding the pre-processed data 1130 into a ML model to form a trained model 1116. The training process adjusts its parameters until it achieves an initial level of satisfactory performance.

The model trainer 1114 may be communicatively coupled to a model evaluator 1120. After a ML model is trained, the trained model 1116 needs to be evaluated to assess its performance. This is done using various metrics such as accuracy, precision, recall, and F1 score. The model trainer 1114 may output the trained model 1116, which is received as input 1112. The model evaluator 1120 receives the trained model 1116, and it initiates an evaluation process to measure performance of the trained model 1116. The evaluation process may include providing feedback 1132 to the model trainer 1114, so that it may re-train the trained model 1116 to improve performance in an iterative manner.

The model evaluator 1120 may be communicatively coupled to a model inferencer 1126. The model inferencer 1126 provides AI/ML model inference output (e.g., predictions or decisions). Once the ML model is trained and evaluated, it can be deployed in a production environment where it can be used to make predictions on new data. The model inferencer 1126 receives the evaluated model 1122 as input 1124. The model inferencer 1126 may use the evaluated model 1122 as a deployed model 1128, which is a final production ML model. The inference output of the deployed model 1128 is use case specific. The model inferencer 1126 may also perform model monitoring and maintenance, which involves continuously monitoring performance of the deployed model 1128 in the production environment and making any necessary updates or modifications to maintain its accuracy and effectiveness. The model inferencer 1126 may provide feedback 1132 to the data collector 1106 to train or re-train the ML model. The feedback 1132 may include model performance feedback information, which may be used for monitoring and improving performance of the deployed model 1128.

The model inferencer 1126 may be implemented by various actors 1136 in the training system 1100. The actors 1136 may use the deployed model 1128 on new data to make inferences or predictions for a given task. The actors 1136 may actually implement the model inferencer 1126, or receive outputs from the model inferencer 1126 in a distributed computing manner. The actors 1136 may trigger actions directed to other entities or to itself. The actors 1136 may provide feedback 1134 to the data collector 1106 via the model inferencer 1126. The feedback 1134 may comprise data needed to derive training data, inference data or to monitor the performance of the AI/ML model and its impact to the network through updating of key performance indicators (KPIs) and performance counters.

The training system 1100 may be applicable to various use cases and solutions for AI/ML tasks, such as the inferencing system 300 and/or training system 400. Other use cases and solutions for AI/ML are possible as well, and embodiments are not limited in this context.

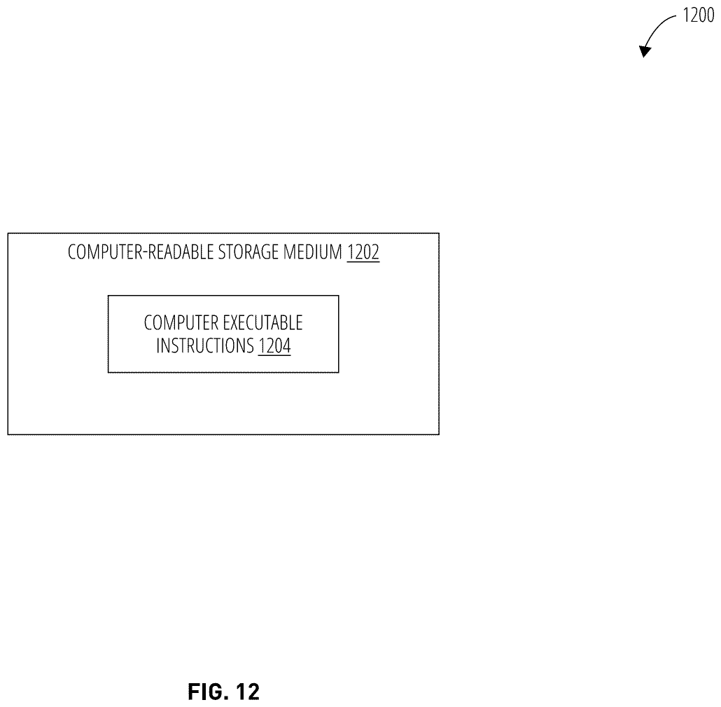

FIG. 12 illustrates an apparatus 1200. Apparatus 1200 may comprise any non-transitory computer-readable storage medium 1202 or machine-readable storage medium, such as an optical, magnetic or semiconductor storage medium. In various embodiments, apparatus 1200 may comprise an article of manufacture or a product. In some embodiments, the computer-readable storage medium 1202 may store computer executable instructions with which circuitry can execute. For example, computer executable instructions 1204 can include instructions to implement operations described with respect to any logic flows described herein. Examples of computer-readable storage medium 1202 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1204 may include any suitable type of code, such as source code, compiled code, interpreted code, executable code, static code, dynamic code, object-oriented code, visual code, and the like.

FIG. 13 illustrates an embodiment of a computing architecture 1300. Computing architecture 1300 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1300 may have a single processor with one core or more than one processor. Note that the term “processor” refers to a processor with a single core or a processor package with multiple processor cores. In at least one embodiment, the computing architecture 1300 is representative of the components of the inferencing system 300. More generally, the computing architecture 1300 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1300. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 13, computing architecture 1300 comprises a system-on-chip (SoC) 1302 for mounting platform components. System-on-chip (SoC) 1302 is a point-to-point (P2P) interconnect platform that includes a first processor 1304 and a second processor 1306 coupled via a point-to-point interconnect 1370 such as an Ultra Path Interconnect (UPI). In other embodiments, the computing architecture 1300 may be of another bus architecture, such as a multi-drop bus. Furthermore, each of processor 1304 and processor 1306 may be processor packages with multiple processor cores including core(s) 1308 and core(s) 1310, respectively. While the computing architecture 1300 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform may refers to a motherboard with certain components mounted such as the processor 1304 and chipset 1332. Some platforms may include additional components and some platforms may only include sockets to mount the processors and/or the chipset. Furthermore, some platforms may not have sockets (e.g. SoC, or the like). Although depicted as a SoC 1302, one or more of the components of the SoC 1302 may also be included in a single die package, a multi-chip module (MCM), a multi-die package, a chiplet, a bridge, and/or an interposer. Therefore, embodiments are not limited to a SoC.

The processor 1304 and processor 1306 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 1304 and/or processor 1306. Additionally, the processor 1304 need not be identical to processor 1306.

Processor 1304 includes an integrated memory controller (IMC) 1320 and point-to-point (P2P) interface 1324 and P2P interface 1328. Similarly, the processor 1306 includes an IMC 1322 as well as P2P interface 1326 and P2P interface 1330. IMC 1320 and IMC 1322 couple the processor 1304 and processor 1306, respectively, to respective memories (e.g., memory 1316 and memory 1318). Memory 1316 and memory 1318 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 1316 and the memory 1318 locally attach to the respective processors (i.e., processor 1304 and processor 1306). In other embodiments, the main memory may couple with the processors via a bus and shared memory hub. Processor 1304 includes registers 1312 and processor 1306 includes registers 1314.

Computing architecture 1300 includes chipset 1332 coupled to processor 1304 and processor 1306. Furthermore, chipset 1332 can be coupled to storage device 1350, for example, via an interface (I/F) 1338. The I/F 1338 may be, for example, a Peripheral Component Interconnect-enhanced (PCIe) interface, a Compute Express Link® (CXL) interface, or a Universal Chiplet Interconnect Express (UCIe) interface. Storage device 1350 can store instructions executable by circuitry of computing architecture 1300 (e.g., processor 1304, processor 1306, GPU 1348, accelerator 1354, vision processing unit 1356, or the like). For example, storage device 1350 can store instructions for device 302, devices 312, devices 316, or the like.

Processor 1304 couples to the chipset 1332 via P2P interface 1328 and P2P 1334 while processor 1306 couples to the chipset 1332 via P2P interface 1330 and P2P 1336. Direct media interface (DMI) 1376 and DMI 1378 may couple the P2P interface 1328 and the P2P 1334 and the P2P interface 1330 and P2P 1336, respectively. DMI 1376 and DMI 1378 may be a high-speed interconnect that facilitates, e.g., eight Giga Transfers per second (GT/s) such as DMI 3.0. In other embodiments, the processor 1304 and processor 1306 may interconnect via a bus.

The chipset 1332 may comprise a controller hub such as a platform controller hub (PCH). The chipset 1332 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1332 may comprise more than one controller hub such as a chipset with a memory controller hub, a graphics controller hub, and an input/output (I/O) controller hub.

In the depicted example, chipset 1332 couples with a trusted platform module (TPM) 1344 and UEFI, BIOS, FLASH circuitry 1346 via I/F 1342. The TPM 1344 is a dedicated microcontroller designed to secure hardware by integrating cryptographic keys into devices. The UEFI, BIOS, FLASH circuitry 1346 may provide pre-boot code.

Furthermore, chipset 1332 includes the I/F 1338 to couple chipset 1332 with a high-performance graphics engine, such as, graphics processing circuitry or a graphics processing unit (GPU) 1348. In other embodiments, the computing architecture 1300 may include a flexible display interface (FDI) (not shown) between the processor 1304 and/or the processor 1306 and the chipset 1332. The FDI interconnects a graphics processor core in one or more of processor 1304 and/or processor 1306 with the chipset 1332.

The computing architecture 1300 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Additionally, accelerator 1354 and/or vision processing unit 1356 can be coupled to chipset 1332 via I/F 1338. The accelerator 1354 is representative of any type of accelerator device (e.g., a data streaming accelerator, cryptographic accelerator, cryptographic co-processor, an offload engine, etc.). One example of an accelerator 1354 is the Intel® Data Streaming Accelerator (DSA). The accelerator 1354 may be a device including circuitry to accelerate copy operations, data encryption, hash value computation, data comparison operations (including comparison of data in memory 1316 and/or memory 1318), and/or data compression. For example, the accelerator 1354 may be a USB device, PCI device, PCIe device, CXL device, UCIe device, and/or an SPI device. The accelerator 1354 can also include circuitry arranged to execute machine learning (ML) related operations (e.g., training, inference, etc.) for ML models. Generally, the accelerator 1354 may be specially designed to perform computationally intensive operations, such as hash value computations, comparison operations, cryptographic operations, and/or compression operations, in a manner that is more efficient than when performed by the processor 1304 or processor 1306. Because the load of the computing architecture 1300 may include hash value computations, comparison operations, cryptographic operations, and/or compression operations, the accelerator 1354 can greatly increase performance of the computing architecture 1300 for these operations.

The accelerator 1354 may include one or more dedicated work queues and one or more shared work queues (each not pictured). Generally, a shared work queue is configured to store descriptors submitted by multiple software entities. The software may be any type of executable code, such as a process, a thread, an application, a virtual machine, a container, a microservice, etc., that share the accelerator 1354. For example, the accelerator 1354 may be shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1354 via a non-posted write (e.g., a deferred memory write (DMWr)). One example of an instruction that atomically submits a work descriptor to the shared work queue of the accelerator 1354 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1354. The dedicated work queue may accept job submissions via commands such as the movdir64b instruction.

Various I/O devices 1360 and display 1352 couple to the bus 1372, along with a bus bridge 1358 which couples the bus 1372 to a second bus 1374 and an I/F 1340 that connects the bus 1372 with the chipset 1332. In one embodiment, the second bus 1374 may be a low pin count (LPC) bus. Various devices may couple to the second bus 1374 including, for example, a keyboard 1362, a mouse 1364 and communication devices 1366.

Furthermore, an audio I/O 1368 may couple to second bus 1374. Many of the I/O devices 1360 and communication devices 1366 may reside on the system-on-chip (SoC) 1302 while the keyboard 1362 and the mouse 1364 may be add-on peripherals. In other embodiments, some or all the I/O devices 1360 and communication devices 1366 are add-on peripherals and do not reside on the system-on-chip (SoC) 1302.

FIG. 14 illustrates a block diagram of an exemplary communications architecture 1400 suitable for implementing various embodiments as previously described. The communications architecture 1400 includes various common communications elements, such as a transmitter, receiver, transceiver, radio, network interface, baseband processor, antenna, amplifiers, filters, power supplies, and so forth. The embodiments, however, are not limited to implementation by the communications architecture 1400.

As shown in FIG. 14, the communications architecture 1400 includes one or more clients 1402 and servers 1404. The clients 1402 may implement a client version of the device 302, for example. The servers 1404 may implement a server version of the device 302, for example. The clients 1402 and the servers 1404 are operatively connected to one or more respective client data stores 1408 and server data stores 1410 that can be employed to store information local to the respective clients 1402 and servers 1404, such as cookies and/or associated contextual information.

The clients 1402 and the servers 1404 may communicate information between each other using a communication framework 1406. The communications communication framework 1406 may implement any well-known communications techniques and protocols. The communications communication framework 1406 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

(117) The communication framework 1406 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/300/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1402 and the servers 1404. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1—______may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

### Terminology

Tool Implant Metrics—Items measured to confirm wafer will be implanted as expected, e.g., energy, species, charge, ROI current, beam height, beam width, angles, angle spread, etc.

Control Inputs/Tuning Knobs—Set of parameters used to create desired Tool Implant Metrics, e.g., Accelerator, Manipulator position, Analyzer Current, Focus Voltage, Extraction Voltage, Q3, Corrector Current, etc.

Dependent Outputs—parameters which vary with control inputs but are not part of the set of process metrics. For example, using a current controller setting as an input, but use its voltage feedback as a dependent output for inferring impedance.

Stress Vector—set of parameters that measure wear and tear on tool, e.g., extraction current & voltage hours by species, gas flow rates, pump/vent cycles, robot moves, etc.

Guide Star Alignment (GSA)—the use of specific setups to do long optical baseline alignment such as source magnet to filter magnet to manipulator to analyzer to corrector to MPXL beam X offset.

Perturbation Sequences for Alignment and Calibration (PSAC)—single GSA can be inconclusive due to combined interactions of Manipulator, Analyzer Current (multiple unknowns). Orthogonal perturbations can provide sufficient ‘multiple equations’ for solving ‘multiple unknowns’ for n-dimensional calibration

Process Param Sieve—Large set of process params (Metrics) derived from training set and/or forward process model stored as large vector set (˜100,000). As customers pin down aspects of desired process params, the set intersection is calculated, with user input restricted to set intersection. This makes sure that the desired process parameters can be achieved by the tool. Can be used offline and displayed as set of micro histograms that adjust to process param windows

Back Propagation (Stochastic)—working backwards from outputs to inputs, assessing what minor nudge to previous layer results in a move towards the desired output (i.e. do a better job predicting the output). These are done in batches, with the nudges stochastically combined.

Locked Layer Learning—Allows Back Propagation to pass through Neural Net (NN) layers for the purpose of updating only those layers that are not locked

Gradient Based Saliency Map—back propagation of an output difference or perturbation to identify the most important inputs that affected that difference

Regression Neural Network—unlike a classifier network, which uses a Boolean activation function (each neuron evaluates to 0 or 1), a regression NN uses a linear activation function (a bias plus a sum of all values connecting from previous layer). The result is a continuous output value

Transfer Learning—Model trained on one thing can be repurposed to do a related task

Invertible Neural Network (INN)—If input layer variation always results in unique outputs, the model can be run forward to create a training set where the outputs become the inputs. If there are cases where output may be duplicated for 2 or more different inputs, we have two options for inverting the model: (1) Identify duplicates, score them and eliminate all but best output; and (2)»Introduce an attribute to the output layer that categorizes each one of the duplicates appropriately.

The following examples pertain to further embodiments, from which numerous permutations and configurations will be apparent.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method, comprising:
receiving a set of control parameters and associated values for an ion implanter by a control model, the control model comprising an artificial neural network (ANN);
predicting a set of process parameters and associated values for the ion implanter based on the set of control parameters and associated values by the control model;
modifying at least one process parameter and associated value from the set of process parameters and associated values for the ion implanter;
analyzing modifications to the set of control parameters and associated values based on the modification of the at least one process parameter by a saliency model; and
recommending a modified set of control parameters and associated values for the ion implanter.

2. The method of claim 1, wherein the control model comprises an input layer, an output layer, and multiple hidden layers, comprising:
locking the multiple hidden layers so that weights and biases of neurons for the locked multiple hidden layers cannot be changed; and
unlocking the input layer and the output layer so that weights and biases of neurons for the unlocked input layer and the unlocked output layer can be changed.

3. The method of claim 1, comprising scoring the modifications to the set of control parameters and associated values by a scoring model.

4. The method of claim 1, comprising scoring the modifications to the set of control parameters and associated values by a scoring model, wherein the scoring model generates a score for ease of tuning components of the ion implanter or a score for stability of tuning components of the ion implanter.

5. The method of claim 1, comprising recommending the modified set of control parameters and associated values based on a score associated with the modified set of control parameters.

6. The method of claim 1, comprising validating the modifications to the set of control parameters and associated values using forward propagation validation by the saliency model.

7. The method of claim 1, comprising presenting a modified set of control parameters and associated values on a graphical user interface (GUI) of an electronic display.

8. The method of claim 1, comprising configuring a component of the ion implanter based on a modified set of control parameters.

9. The method of claim 1, comprising causing generation of an ion beam by the ion implanter based on a modified set of control parameters.

10. An ion implanter, comprising:
an ion source to generate an ion beam;
at least one beamline component to direct the ion beam towards a substrate;
a processing circuitry; and
a memory communicatively coupled to the processing circuitry, the memory storing instructions that, when executed by the processing circuitry, causes the processing circuitry to:
receive a set of control parameters and associated values for the ion implanter by a control model, the control model comprising an artificial neural network (ANN);
predict a set of process parameters and associated values for the ion implanter based on the set of control parameters and associated values by the control model;
modify at least one process parameter and associated value from the set of process parameters and associated values for the ion implanter; and
analyze modifications to the set of control parameters and associated values based on the modification of the at least one process parameter by a saliency model.

11. The ion implanter of claim 10, wherein the control model comprises an input layer, an output layer, and multiple hidden layers, comprising:
lock the multiple hidden layers so that weights and biases of neurons for the locked multiple hidden layers cannot be changed; and
unlock the input layer and the output layer so that weights and biases of neurons for the unlocked input layer and the unlocked output layer can be changed.

12. The ion implanter of claim 10, the processing circuitry to score the modifications to the set of control parameters and associated values by a scoring model.

13. The ion implanter of claim 10, the processing circuitry to recommend a modified set of control parameters and associated values based on a score associated with the modified set of control parameters.

14. The ion implanter of claim 10, the processing circuitry to validate the modifications to the set of control parameters and associated values using forward propagation validation by the saliency model.

15. The ion implanter of claim 10, the processing circuitry to configure the at least one beamline component of the ion implanter based on a modified set of control parameters recommended by the control model and the saliency model.

16. The ion implanter of claim 10, the processing circuitry to cause the ion source to generate the ion beam, and the at least one beamline component to direct the ion beam towards the substrate, based on a modified set of control parameters recommended by the control model and the saliency model.

17. An ion implanter, comprising:
an ion source to generate an ion beam;
at least one beamline component to direct the ion beam towards a substrate;
circuitry operably coupled to the at least one beamline component, the circuitry to:
receive a set of control parameters and associated values for the ion implanter by a control model, the control model comprising an artificial neural network (ANN);
predict a set of process parameters and associated values for the ion implanter based on the set of control parameters and associated values by the control model;
modify at least one process parameter and associated value from the set of process parameters and associated values for the ion implanter by a saliency model;
recommend a modified set of control parameters and associated values based on an analysis of the modification of the at least one process parameter by the saliency model; and
configure the at least one beamline component of the ion implanter based on the modified set of control parameters.

18. The ion implanter of claim 17, wherein the control model comprises an input layer, an output layer, and multiple hidden layers, the circuitry to:
lock the multiple hidden layers so that weights and biases of neurons for the locked multiple hidden layers cannot be changed; and
unlock the input layer and the output layer so that weights and biases of neurons for the unlocked input layer and the unlocked output layer can be changed.

19. The ion implanter of claim 17, the circuitry to:
score the modifications to the set of control parameters and associated values by a scoring model; and
recommend the modified set of control parameters and associated values based on a score associated with the modified set of control parameters.

20. The ion implanter of claim 17, the circuitry to cause the ion source to generate the ion beam, and the at least one beamline component to direct the ion beam towards the substrate, based on the modified set of control parameters.
